(19) United States
(12) Patent Application Publication
(10) Pub. No.: US 2008/0053875 A1
(43) Pub. Date: Mar. 6, 2008

(54) Document sorting machine

(75) Inventors: Simon Calverley, Horndean (GB); John Alan Skinner, Havant (GB); Steven Michael Hosking, Waterlooville (GB); Antony John Leonard, Gosport (GB)

Correspondence Address: OLIFF & BERRIDGE, PLC, P.O. BOX 320850, ALEXANDRIA, VA, 22320-4850, US

(73) Assignee: DE LA RUE INTERNATIONAL LIMITED, BASINGSTOKE (GB)

(21) Appl. No.: 11/898,029

(22) Filed: Sep. 7, 2007

Related U.S. Application Data
(62) Division of application No. 11/628,200, filed on Jan. 24, 2007.
(60) Provisional application No. 60/576,629, filed on Jun. 4, 2004.
(60) Provisional application No. 60/631,160, filed on Nov. 29, 2004.

(51) Int. Cl. B07C 5/34

(52) U.S. Cl. 209/534; 270/58.04

(57) ABSTRACT

A document feeder system for use in a document sorting apparatus is disclosed. The document feeder system comprises upper and lower portions, each having respective feeder elements for feeding documents from a hopper, the upper and lower portions being movable relative to one another between a feeding position, in which the feeder elements of the upper and lower portions are engageable with a document to be fed, and a jam clearance position, in which a document between the feeder elements of the upper and lower portions may be retrieved, wherein the upper and lower portions are urged into the feeding position by a constant force spring.

This is a Divisional of application Ser. No. 11/628,200 which is the U.S. National Stage of PCT/GB2005/002190 filed Jun. 6, 2005 and which claims the benefit of U.S. Provisional Applications No. 60/576,629 filed Jun. 4, 2004 and No. 60/631,160 filed Nov. 29, 2004. The disclosure of each prior application is hereby incorporated by reference herein in its entirety.

### INTRODUCTION

This invention relates to a machine for sorting documents, and in particular banknotes. The banknotes are placed in a feeder at the bottom of the machine and fed via a transport through a detector system which measures one or more characteristics of the banknotes and these characteristics are used to decide which of a plurality of diverters to operate so as to divert the banknotes into the correct output pockets. Any banknotes that are not diverted by one of the diverters are fed into a cull pocket.

The banknotes may be sorted on any one of a plurality of characteristics, for example, currency, denomination, note facing, orientation, note fitness or indeed, on the basis of authentication features.

### STATEMENT OF INVENTION

It is an object of the invention to overcome some of the deficiencies of prior art sorting machines, and various aspects of the invention that achieve this object are set out below.

In accordance with one aspect of the present invention, there is provide a document feeder system for use in a document sorting apparatus, the document feeder system comprising upper and lower portions, each having respective feeder elements for feeding documents from a hopper, the upper and lower portions being movable relative to one another between a feeding position, in which the feeder elements of the upper and lower portions are engageable with a document to be fed, and a jam clearance position, in which a document between the feeder elements of the upper and lower portions may be retrieved, wherein the upper and lower portions are urged into the Seeding position by a constant force spring.

Prior art systems have typically held the upper and lower portions of a feeder system together by means of a latch. The two portions are normally spring-biased apart from each other so that they separate when the latch is released. Hence, by urging the upper and lower portions into the feeding position by a constant force spring, the latch may be dispensed with. The constant force spring ensures that the force required to hold the two portions apart does not increase as they are separated, which would be the case if a helical spring were used.

The feeder elements of the upper and lower portions may be disposed such that when the upper and lower portions are in the feeding position, each feeder element of the upper portion is juxtaposed with a corresponding feeder element in the lower portion.

Typically, the feeder system further comprises means for adjusting the separation between the feeder elements when the upper and lower portions are in the feeding position. Such means may comprise a thumb wheel adjuster, for example.

In a second aspect of the invention, there is provided a document feeder system for use in a document sorting apparatus, the document feeder system comprising a dc drive motor and a drive motor controller adapted to cause documents to be fed in a forward direction in response to assertion of a feeding signal by applying a forward polarity excitation to the drive motor, and to cease the Seeding of documents in response to negation of the feeding signal by bringing the drive motor to rest by applying a reverse polarity excitation of a first magnitude to the drive motor for a predetermined duration.

In accordance with a third aspect of the invention, there is provided a method for controlling the drive motor of a document feeder system, the method comprising causing documents to be fed in a forward direction in response to assertion of a feeding signal by applying a forward polarity excitation to the drive motor, and to cease the feeding of documents in response to negation of the feeding signal by bringing the drive motor to rest by applying a reverse polarity excitation of a first magnitude to the drive motor for a predetermined duration.

Hence, by providing a short period of reverse drive, the drive motor is brought to rest as rapidly as possible thereby helping to prevent the misfeeding of documents.

In one embodiment, the drive motor controller is further adapted to apply no excitation to the drive motor after the predetermined duration has expired, and until the feeding signal is subsequently asserted.

However, in another embodiment, the drive motor controller is further adapted to apply a reverse excitation of a second magnitude to the drive motor after the predetermined duration has expired, and until the feeding signal is subsequently asserted, wherein the second magnitude is lower than the first magnitude. The second magnitude is normally selected such that it is not sufficient to overcome the inertia of the motor and cause it to rotate, but will not cause damage to the motor if applied indefinitely. This provides an additional advantage in that the feeder is positively locked to help prevent notes slipping through.

The document feeder system may further comprise a speed sensor for measuring the speed of the drive motor, the speed sensor being connected to the drive motor controller, which is further adapted to adjust the predetermined duration in accordance with a measured speed value of the drive motor when the feeding signal is asserted.

In this case, the drive motor controller may be adapted to adjust the predetermined duration to be a predetermined proportion of the measured speed value.

In accordance with a fourth aspect of the invention, there is provided a document feeder system for use in a document sorting apparatus, the document feeder system comprising upper and lower portions disposed on opposite sides of a document path, the upper and lower portions being movable relative to one another between a feeding position and a jam clearance position, the feeder system further comprising a sensor system for detecting the passage of documents along the document path, the sensor system having an emitter being adapted to emit visible light which impinges on a first region of the document path including the receiver when the upper and lower portions of the feeder system are in the feeding position and no document is present in the first region, and which impinges on a second region of the document path when the upper and lower portions of the feeder system are in the jam clearance position, wherein the sensor system further comprises a controller connected to the emitter and receiver and adapted to adjust the intensity of light emitted by the emitter in accordance with the intensity of light received by the receiver such that when the upper and lower portions of the feeder system are in the jam clearance position the second region of the document path is illuminated by the light emitted from the emitter.

Hence, by increasing the intensity of light when the level received by the receiver diminishes, the invention provides a useful illumination of a region of the document path when the upper and lower portions of the feeder system are placed in the jam clearance position (this automatically diminishes the quantity of light emitted by the emitter that impinges on the receiver.

Typically, the second region of the document path excludes the receiver.

In a preferred embodiment, the visible light emitted by the emitter is yellow in colour. This is a useful colour to use since the human eye is particularly sensitive to yellow light, and it provides a high contrast illumination on a variety of surfaces.

Normally, the controller is adapted to adjust the intensity of light emitted by the emitter in inverse proportion with the intensity of light received by the receiver.

Typically, the controller is adapted to adjust the intensity of light emitted by the emitter such that it emits light at a maximum intensity when no light emitted by the emitter is received by the receiver.

In one embodiment, the controller is adapted to adjust the intensity of light emitted by the emitter to be at one of a plurality of discrete levels, each level corresponding to a respective range of light intensity received by the receiver.

In accordance with a fifth aspect of the invention, there is provided a document sorting device having a document transport; an output pocket associated with a diverter for diverting selected documents from the transport into the output pocket; and a first sensor for detecting the presence of a document in a region of the transport downstream from the diverter, wherein the first sensor is connected to a controller adapted to indicate that a document has been diverted into the output pocket when the first sensor fails to detect the document.

This aspect of the invention provides a reliable sensing mechanism to sense that a document has been successfully diverted without resorting to the expense of prior art systems which typically require a sensor in the path of diverted documents.

In a preferred embodiment, the device further comprises a second sensor for detecting the presence of a document in a region of the transport upstream from the diverter, wherein the second sensor is connected to the controller, and wherein the controller is further adapted to indicate that the document has been diverted into the output pocket if the first sensor does not detect the presence of the document within a predetermined time after the document has been detected by the second sensor.

Typically, the predetermined time is set in accordance with the speed of the document transport.

Advantageously, the controller may be further adapted to stop the document transport if the first sensor does detect a document that was expected to be diverted to the output pocket.

In a sixth aspect of the invention, there is provided a document stacking system for stacking documents received from a transport path in a mixture of face-up and face-down configurations, the stacking system comprising a diverter capable of diverting each document along either a first path leading directly to an output pocket or along a second path leading to the output pocket via a stacking wheel adapted to reverse the face configuration of documents diverted along the second path and deposit them in the output pocket, wherein the system further comprises a controller adapted to actuate the diverter such that documents in a face-up configuration are diverted along a predetermined one of the first and second paths, and documents in a face-down configuration are diverted along the other of the first and second paths, such that all documents are stacked in the output pocket in the same face configuration.

In a seventh aspect of the invention, there is provided a method of stacking documents received in a mixture of face-up and face-down configurations, the method comprising diverting documents in a face-up configuration along a predetermined one of a first and a second path, and diverting documents in a face-down configuration along the other of the first and second paths, wherein documents diverted along the first path are deposited directly in the output pocket, and documents diverted along the second path are inverted and deposited in the output pocket by a stacker wheel such that all documents are stacked in the output pocket in the same face configuration.

Prior art systems typically require two pockets to sort documents provided in a mixture of face-up and face-down configurations. The face-up documents are sent to a first pocket and the face-down documents are sent to a second pocket. A user then combines the notes from the two pockets, inverting one of them. This aspect of the invention therefore provides a relatively cost-effective way of sorting documents into a single stack all facing the same way without occupying two pockets and requiring a further user action.

The system normally further comprises a detector connected to the controller and disposed adjacent the transport path upstream from the diverter, wherein the detector is adapted to indicate to the controller whether each passing note is in the face-up or face-down configuration.

The detector may use a pattern recognition algorithm to ascertain whether each passing note is in the face-up or face-down configuration.

In a preferred embodiment, the first and second paths are defined by respective pairs of belts entrained around rollers.

In accordance with a eighth aspect of the invention, there is provided a document sorting device comprising a document transport, an output pocket and a controller, the output pocket having an associated diverter and a tine wheel for stacking the documents in the output pocket, the controller being adapted, when a document matches a predefined set of characteristics, to activate the diverter and cause the tine wheel of the associated output pocket to come to rest such that the document is retained in the tines of the tine wheel.

In an ninth aspect of the invention, there is a method of indicating to a user of a document sorting device that a document matches a predefined set of characteristics, the method comprising diverting the document from a document path towards an output pocket with a tine wheel, and causing the tine wheel to come to rest such that the document is retained in the tines of the tine wheel.

This provides an extremely useful way of indicating a note matching a specific set of characteristics to a user. For example, it may be used to indicate to a user that a note is counterfeit.

In a preferred embodiment, the tine wheel is caused to come to rest such that the document is retained in the tines of the tine wheel in a substantially vertical orientation.

Typically, the diverter has an associated sensor for sensing the presence of a document in a region of the document transport upstream from the diverter, and wherein the controller is further adapted to cause the tine wheel to come to rest a predetermined time after the presence of a document matching the predefined set of characteristics has been sensed by the sensor.

Preferably, the document transport and tine wheel are driven by first and second drive motors respectively controlled by respective drive signals supplied by the controller. This independent driving of the transport and tine wheel is helpful since the transport may then continue to run even after the tine wheel has been stopped.

In this case, the controller is normally adapted to cause the tine wheel to come to rest by negating the drive signal supplied to the second drive motor, and the controller is then preferably further adapted to continue asserting the drive signal supplied to the first drive motor when the drive signal supplied to the second drive motor has been negated.

Typically, the predefined set of characteristics will define the document as a counterfeit document.

In a tenth aspect of the invention, there is provided a document sorting device comprising a document transport, at least one output pocket and associated diverter, a plurality of detectors, and a controller connected to the detectors and the diverter, wherein the controller is adapted to receive a signal from each detector, multiply each received signal by a respective weighting factor to form respective weighted signals, calculate the sum of all the weighting signals, and activate the diverter if the sum of all the weighting signals meets a predefined criterion.

In accordance with a eleventh aspect of the invention, there is provided a method of sorting documents comprising detecting a quantitative measure of a plurality of characteristics of a document, each characteristic being detected by a respective detector that produces a corresponding output signal indicating the quantitative measure of that characteristic; multiplying each output signal by a respective weighting factor to produce a respective weighted signal; and diverting the document into an output pocket if the sum of the weighted signals meets a predefined criterion.

This provides a sophisticated way of sorting documents according to their fitness. For example, it may be that the degree of soil of a document is considered far less important than whether it is torn. Thus, the weighting factor applied to detection of a tear will be correspondingly higher than that applied to detection of soiling. Accordingly, slightly torn documents will be rejected as will heavily soiled documents. In addition, however, a lightly soiled document with a very slight tear may also be rejected.

The predefined criterion may be that the sum of all the weighted signals exceeds a predetermined threshold.

Alternatively, the predefined criterion may be that the sum of all the weighted signals does not exceed a predetermined threshold.

The detectors may be adapted to detect at least two of the following: the degree of soiling of a document; the presence of a tear in a document; the presence of a fold in a document; the presence of a hole in a document; the condition of a thread embedded within a document; and the size of a document.

In an twelfth aspect of the invention, there is provided a banknote sorting device comprising a feeder for feeding a stack of banknotes in use, a document transport, a first output pocket and associated first diverter, a detector for detecting the denomination of a banknote and a controller connected to the detector and the diverter, wherein the controller is adapted to detect the denomination of each banknote fed from the stack; to actuate the first diverter to divert a first predefined banknote from the transport into the first output pocket, and to actuate the first diverter to divert subsequent banknotes having the same denomination as the first predefined banknote into the first output pocket until the first output pocket contains a predetermined value of banknotes.

According to a thirteenth aspect of the invention, there is provided a method of sorting banknotes fed from a stack of banknotes, the method comprising diverting a first predefined banknote and all subsequent banknotes having the same denomination as the first predefined banknote to a first output pocket until the first output pocket contains a predetermined value of banknotes.

This provides a sophisticated sorting process, whereby the quantity of notes stored in a pocket is determined by the denomination of the notes. For example, if the predetermined value Is ,1000, then fifty ,20 would be placed in the pocket whilst one Hundred ,10 would be placed in the pocket.

In one embodiment, the device further comprises a second output pocket and associated second diverter, wherein the controller is further adapted to actuate the second diverter to divert a second predefined banknote from the transport into the second output pocket, and to actuate the second diverter to divert subsequent banknotes having the same denomination as the second predefined banknote into the second output pocket until the second output pocket contains a predetermined value of banknotes.

In another embodiment, the device further comprises a second output pocket and associated second diverter, wherein the controller is further adapted, when the first output pocket contains the predetermined value of banknotes, to actuate the second diverter to divert subsequent banknotes having the same denomination as the first predefined banknote into the second output pocket until the second output pocket contains a predetermined value of banknotes. Thus, as the first pocket is filled, notes may be diverted to the second pocket. The first pocket may then be emptied by the user so that more notes may be sorted into it. This may all be achieved without interrupting the sorting operation.

The first predefined banknote may be the first note fed from the stack of banknotes.

The second predefined banknote may be the first note fed from the stack of banknotes having a denomination different from that of the first note fed from the stack of banknotes.

Preferably, the device further comprises an authenticity detector connected to the controller for detecting counterfeit banknotes, wherein the controller is further adapted to feed any counterfeit banknotes to a cull pocket.

Typically, the controller will achieve this by inhibiting actuation of all diverters.

In accordance with a fourteenth aspect of the invention, there is provide a banknote sorting device having two output pockets, each of which can be designated as a primary or a secondary output pocket, wherein the banknote sorting device is switchable between a sitting mode in which the lower of the two output pockets is designated the primary output pocket and the upper of the two output pockets is designated the secondary output pocket, and a standing mode in which the designation of the primary and secondary output pockets is reversed.

This aspect provides the advantage that a single machine may be used in two scenarios, namely where operators usually stand and where they usually sit to use the machine. Since there are no physical changes to the machine, this setup can be made on installation at a customer=s premises.

Normally, the primary output pocket is a priority pocket, and the priority pocket receives the first note from a stack of banknotes fed into the banknote sorting device that meets a first predefined set of characteristics along with all subsequent notes meeting the first predefined set of characteristics.

In this case, the secondary pocket receives the second note from a stack of banknotes fed into the banknote sorting device that meets a second predefined set of characteristics along with all subsequent notes meeting the second predefined set of characteristics.

The first predefined set of characteristics may include one or more of: a note=s denomination; a note=s fitness; a note=s facing; a note=s orientation; a note=s currency; and a note=s authenticity.

The second predefined set of characteristics may include one or more of: a note=s denomination; a note=s fitness; a note=s facing; a note=s orientation; a note=s currency; and a note=s authenticity.

In a fifteenth aspect of the invention, there is provided a method of sorting banknotes presented in both face-up and face-down configurations using a banknote sorting device having three output pockets, the method comprising sorting banknotes in one of the face-up or face-down configurations and having a first orientation into a first one of the output pockets, sorting banknotes in that configuration and having a second orientation into a second one of the output pockets, and sorting all banknotes in the other of the face-up or face-down configurations into the third output pocket, wherein the method further comprises removing the banknotes sorted into the third output pocket, inverting them to be in the opposite configuration and reintroducing them to the banknote sorting device for further sorting.

In a sixteenth aspect of the invention, there is provided a method of sorting banknotes presented in both forward and reverse orientations using a banknote sorting device having three output pockets, the method comprising sorting banknotes in one of the forward or reverse orientations and having one of a face-up or face-down configuration into a first one of the output pockets, sorting banknotes in that orientation and having the other of the face-up or face-down configuration into a second one of the output pockets, and sorting all banknotes in the other of the forward or reverse configurations into the third output pocket, wherein the method further comprises removing the banknotes sorted into the third output pocket, rotating them so as to be in the opposite orientation and reintroducing them to the banknote sorting device for further sorting.

These aspects provide a flexible method of sorting a stack of notes that are in a mixture of configurations without interrupting the operation of the sorter.

Preferably, the total value of all notes sorted into the first two output pockets only is counted and displayed to a user. Thus, the value of notes fed into the third output pocket are not counted until they have been reintroduced to the sorter.

In a seventeenth aspect of the invention, there is provided a combination of a document feeder system according to the first aspect of the invention and/or a document feeder system according to the second aspect of the invention and/or a document feeder system according to the fourth aspect of the invention and/or a document sorting device according to the fifth aspect of the invention and/or a document stacking system according to the sixth aspect of the invention and/or a document sorting device according to the eighth aspect of the invention and/or a document sorting device according to the tenth aspect of the invention and/or a banknote sorting device according to the twelfth aspect of the invention and/or a banknote sorting device according to the fourteenth aspect of the invention.

In an eighteenth aspect of the invention, there is provided a combination of a method according to the third aspect of the invention and/or a method according to the seventh aspect of the invention and/or a method according to the ninth aspect of the invention and/or a method according to the eleventh aspect of the invention and/or a method according to the thirteenth aspect of the invention and/or a method according to the fifteenth aspect of the invention and/or a method according to the sixteenth aspect of the invention.

### BRIEF DESCRIPTION OF DRAWINGS

FIG. 1 shows a front elevational view of a banknote sorter.

FIG. 2 shows a rear elevational view of the banknote sorter.

FIG. 3 shows a left hand side elevational view of the banknote sorter.

FIG. 4 shows a right hand side elevational view of the banknote sorter.

FIG. 5 shows a front elevational view of the banknote sorter with the casing removed.

FIG. 6 shows a rear elevational view of the banknote sorter with the casing removed.

FIG. 7 shows a left hand side elevational view of the banknote sorter with the casing removed.

FIG. 8 shows a right hand side elevational view of the banknote sorter with the casing removed.

FIG. 9 shows an isometric perspective view of the banknote sorter from the front and right hand sides with its casing removed.

FIG. 10 shows an isometric view from the front and right hand side of the banknote sorter with its casing removed and with a rear access cover in the open position.

FIG. 11 shows an isometric perspective view from the front and right hand side of the banknote sorter with its casing removed and with one of the output pockets pulled forwards in to a jam clearance position to allow access to the transport behind the pocket.

FIG. 12 shows an isometric perspective view from the front and left hand sides of the machine with its casing removed.

FIG. 13 shows an internal cross-sectional view showing the path of the transport belts, and the pinch rollers etc. that constitute the transport.

FIG. 14 shows the two transport belts and the detector system.

FIG. 15 shows the detector system, including its sensors, and the pinch rollers mounted on the rear access cover.

FIG. 16 shows the springs used to hold the pinch rollers on the rear access cover.

FIG. 17 shows a partial underside view of the banknote sorter, showing in particular elements of the feeder system and the doubles detector system.

FIG. 18 shows an isometric perspective view from the front and lefthand sides of the banknote sorter, showing in particular elements of the feeder system and the cull pocket.

FIG. 19 shows a schematic block diagram of the main controller printed circuit board.

FIG. 20 shows a schematic block diagram of the motor controller printed circuit board.

FIG. 21 shows a schematic block diagram of the transport controller printed circuit board.

FIG. 22 shows a view of the keypad and display.

FIGS. 23 and 24 show the doubles detector in detail.

FIG. 25 shows the doubles detector circuitry.

FIG. 26 shows output signals from the doubles detector circuitry.

FIG. 27 shows a side view of part of the banknote sorter.

FIG. 28 shows a diverter assembly.

FIGS. 29 and 30 show side views of a diverter assembly in first and second positions respectively.

FIG. 31 shows the motor current applied to the diverter in response to a divert signal.

FIG. 32 shows a block diagram of a part of the control circuitry for the diverter.

FIGS. 33 and 34 show left and right hand side internal views of an output pocket.

FIG. 35 shows a mechanism for stacking notes presented in face-up and face-down configurations in either one of these configurations.

FIG. 36 shows a mechanism for clearance of jams in the feeder system 4.

FIGS. 37 to 39 show an alternative arrangement for a lower part of the transport.

FIG. 40 shows a cover over the cull pocket.

FIG. 41 shows an alternative arrangement for an upper part of the transport.

FIG. 42 shows an improvement to the feeder.

FIG. 43 shows an alternative mounting arrangement for the output pockets.

FIGS. 44 and 45 shows a cut-away view of part of the feeder.

FIGS. 46 and 47 show cross-sections through the machine.

### DESCRIPTION OF EMBODIMENTS

Embodiments of the abovementioned aspects of the invention will now be described with reference to the abovementioned drawings.

Overview

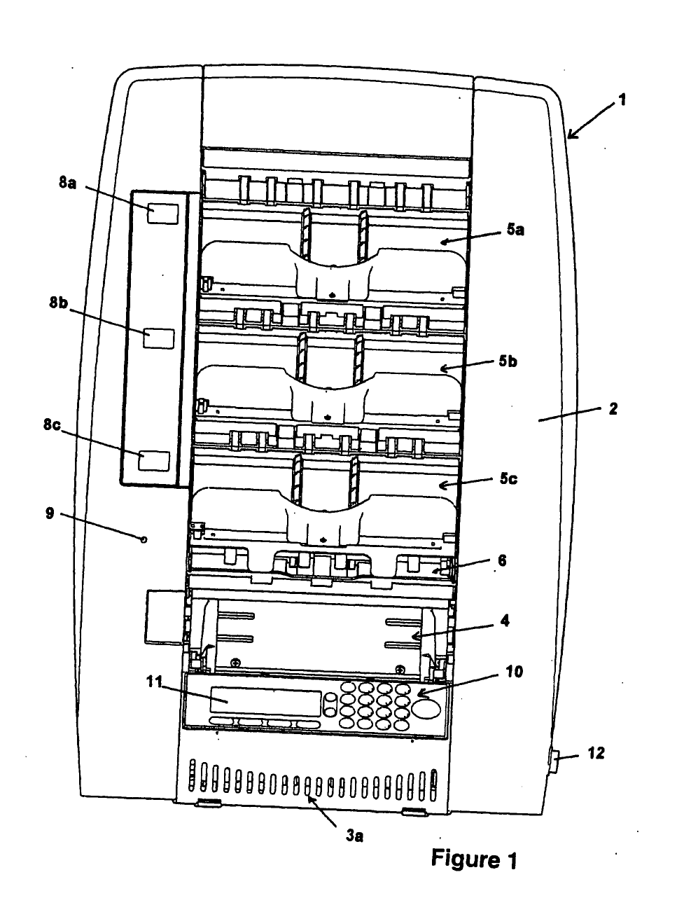

FIGS. 1, 2, 3 and 4 show the banknote sorting machine 1 in front, rear, left hand side and right hand side elevational views respectively.

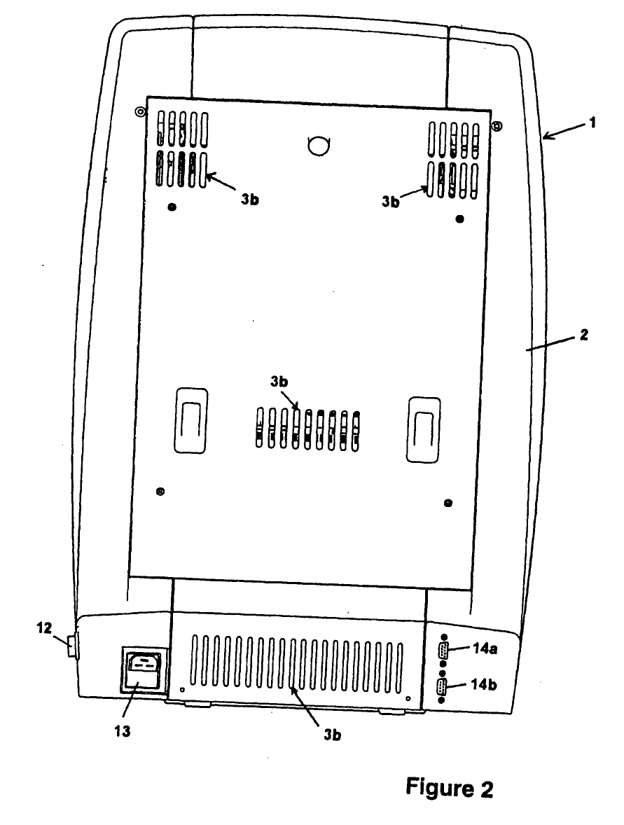

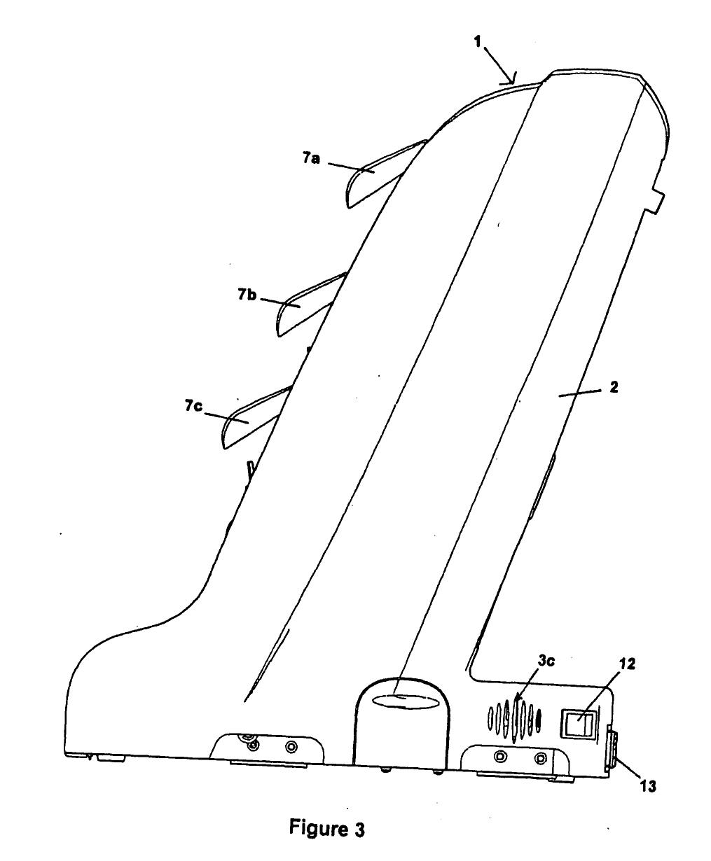

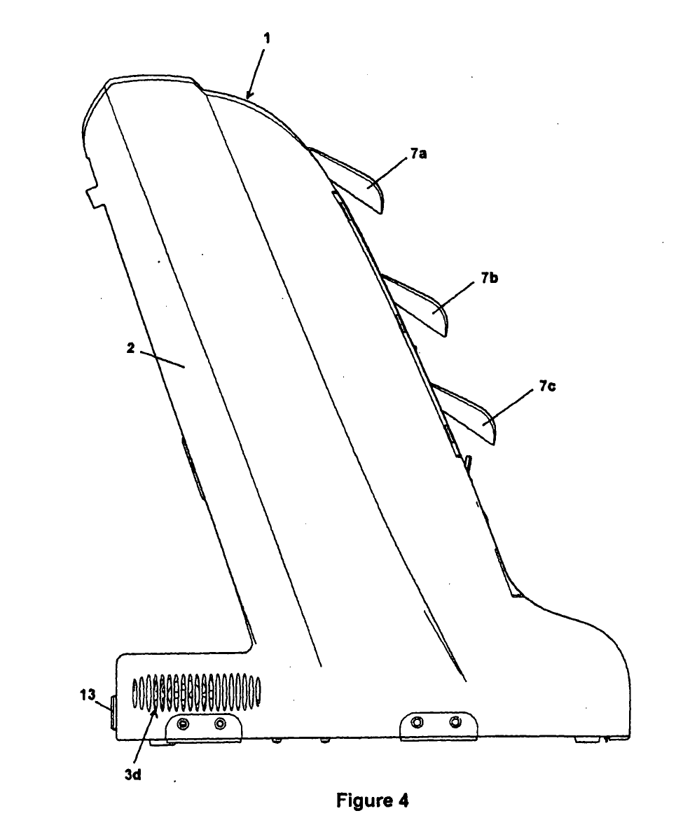

It can be seen from the front elevational view of FIG. 1 that the banknote sorter 1 is enclosed within a casing 2 that is injection moulded from acrylonitrile butadiene styrene (ABS). An array of ventilation holes 3a is provided towards the bottom of the casing to allow passage of air into the banknote sorter 1 in order to prevent it from overheating. The array of ventilation holes 3a works in conjunction with the arrays of ventilation holes 3b,3c and 3d which can be seen in FIGS. 2 to 4 provided in the rear, left hand side and right hand side of the casing of the banknote sorter 1 respectively. Banknotes are stacked on the base of a hopper that is part of the feeder system 4, which will be described in detail later, and are fed into the transport from the feeder system 4. Each note is fed past a detector system, which will be described in detail later, and diverters are operable to divert the banknote from the transport into a respective output pocket 5a,5b and 5c. Any banknote that is not diverted from the transport is stacked in the cull pocket 6. Each of the output pockets 5a-c is covered by a dust cover 7a-c (which can be seen from FIGS. 3 and 4) respectively. These deflect dust particles from the banknotes and prevent them from flying towards an operator=s face.

Each of the output pockets 5a-c has an associated counter display 8a-c. This may be an LED or LCD display and indicates the number, value or currency of banknotes that have been diverted into each of the output pockets 5a-c. The display 8a-c may be caused to flash if the associated pocket 5a-c requires attention, for example because it is full. The cull pocket 6 has an associated cull pocket indicator 9, which may be an incandescent lamp or LED, and indicates the presence of banknotes in the cull pocket.

Operating commands are generally issued to the banknote sorter 1 by means of a keypad 10 and information relating to the operation of the banknote sorter 1 is presented to a user via a display 11. The keypad 10 and display 11 will be described in detail later.

Mains power is supplied to the banknote sorter 1 via a power connector 13 which is normally an IEC style mains connector. The power supply to the banknote sorter 1 may be switched on or off by a power switch 12. The power connector 13 can be seen in detail in FIG. 2 in which are also shown two 9-pin D-type input/output connectors 14a,b. These are used to provide RS-232 connections to a PC or printer. Other types of interface, for example Ethernet or Universal Serial Bus (USB) can be used. For this purpose an internal or external converter may be provided.

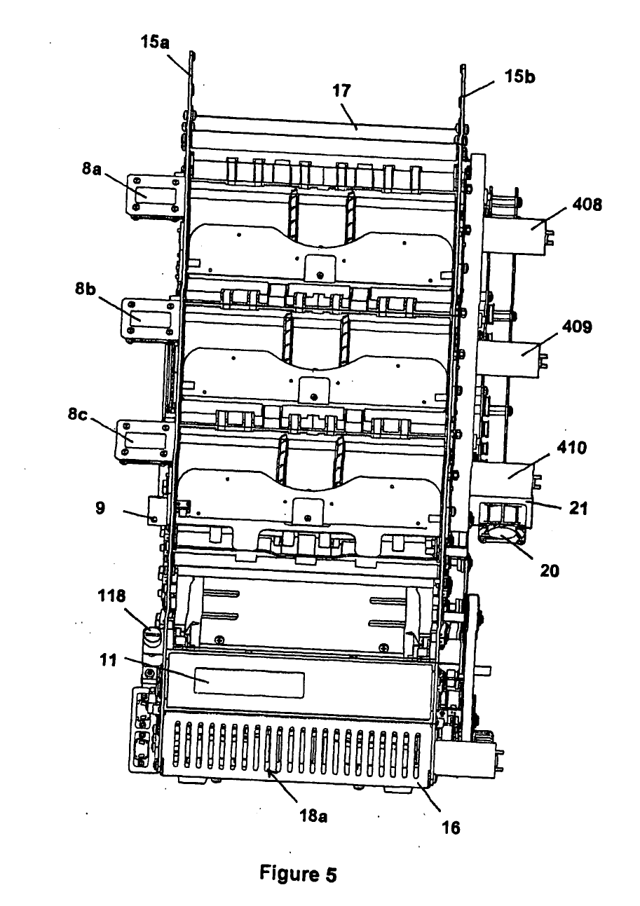

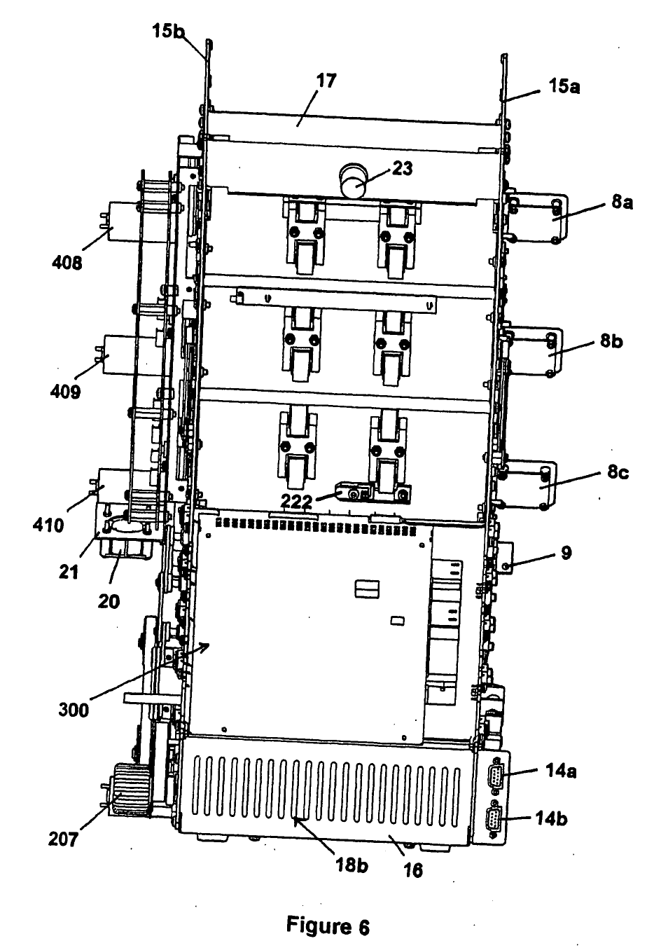

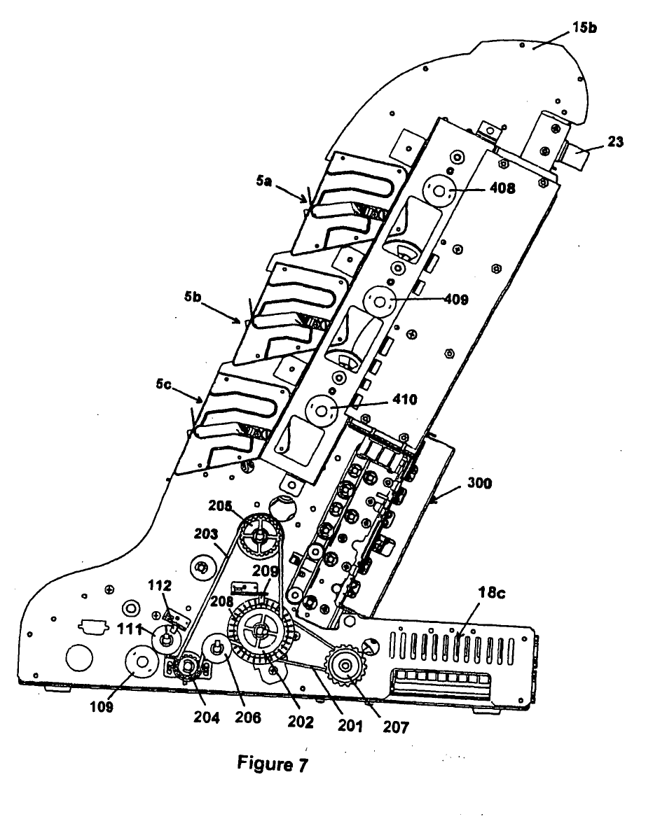

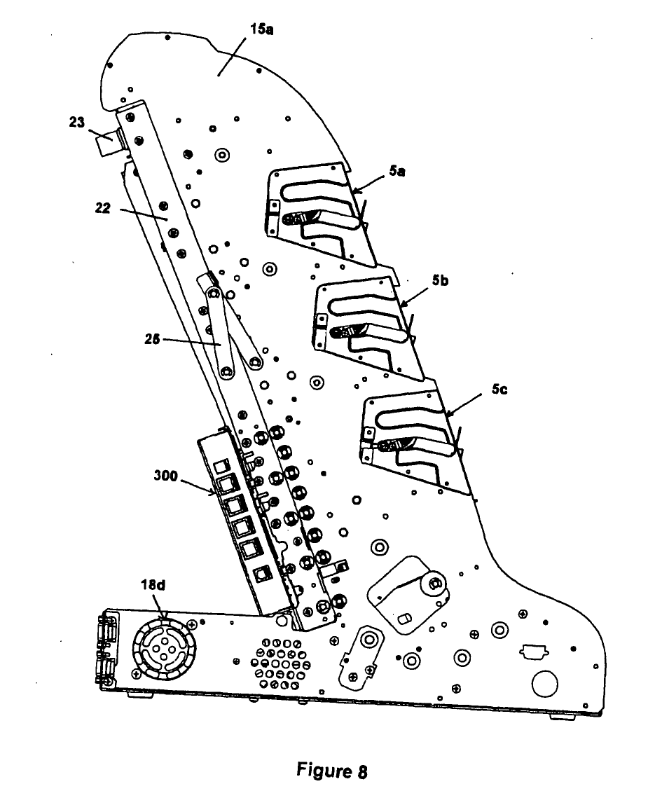

FIGS. 5, 6, 7 and 8 show the banknote sorting machine 1, with the casing 2 removed, in front, rear, left hand side and right hand side elevational views respectively. The banknote sorter 1 is constructed between a right hand side plate 15a and a left hand side plate 15b. The two side plates 15a,15b are fabricated from a suitable metal, such as steel, aluminium, or an aluminium alloy by machining or stamping. A sub-chassis 16 at the base of the banknote sorter 1 and a top bracket 17 are provided to brace the two side plates 15a,15b. The sub-chassis 16 extends underneath the entire banknote sorter 1 and partially up the front and rear of the banknote sorter 1. It is provided with ventilation slots 18a,18b in the front and rear portions respectively.

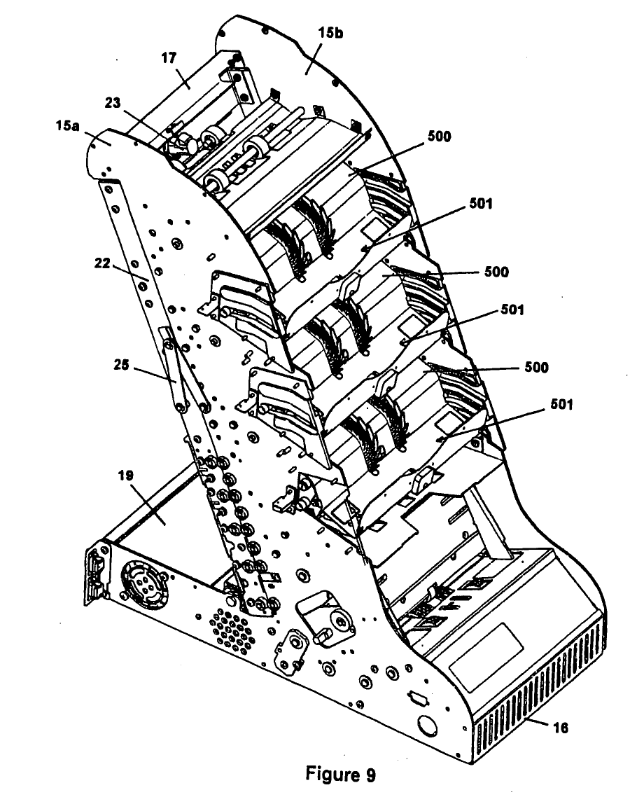

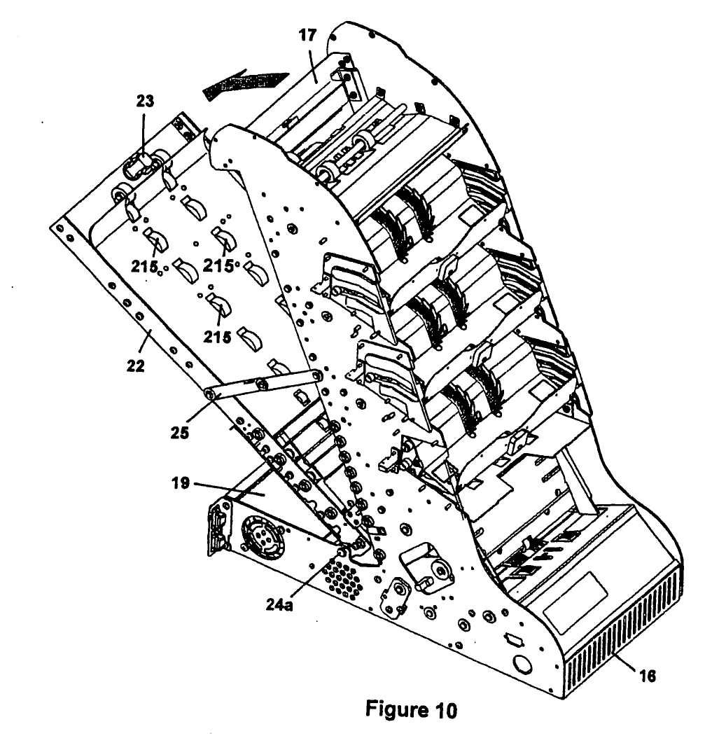

A further array of ventilation holes 18c is provided in the left hand side plate 15b to allow passage of air into a power supply unit 19 (shown in FIGS. 9 and 10).

A fan 10 is mounted on a bracket 21 attached to the left hand side plate 15b, and is operable to force air over the printed circuit boards (PCBs) which are also mounted on the left hand side plate 15b.

The power supply unit is a conventional switch mode power supply, for example the Astec MP4-2T-00, which is a 400 watt power supply. This supply receives mains power from the power connector 13 and provides a DC output that is used to supply the electrical apparatus within the banknote sorter 1.

Jam Clearance

The banknote sorter 1 is provided with three features to facilitate removal of banknotes that have become jammed in the transport. A perspective view of the banknote sorter 1 in its normal, operating configuration is shown in FIG. 9. In this, it can be seen that the banknote sorter 1 is provided with a rear access cover 22.

FIG. 10 shows the rear access cover 22 in its open position. In order to open the rear access cover 22, a latch 23, which normally holds it closed, is released. The rear access cover 22 is then free to pivot about hinge points 24a,24b provided in the right hand and left hand side plates 15a,15b respectively. A restraint bar 25 limits the degree of rotation of the rear access cover 22 about the hinge points 24a,24b and thereby limits the extent of its opening.

In one embodiment, the casing 2 is provided with a hinged access cover (not shown) attached to the rear access cover 22. The latch 23 is operable to allow both the hinged access cover and the rear access cover 22 to pivot together.

When the rear access cover 22 is in the open position the rear portion of the transport is accessible, thereby allowing any trapped notes in that part of the banknote sorter 1 to be removed.

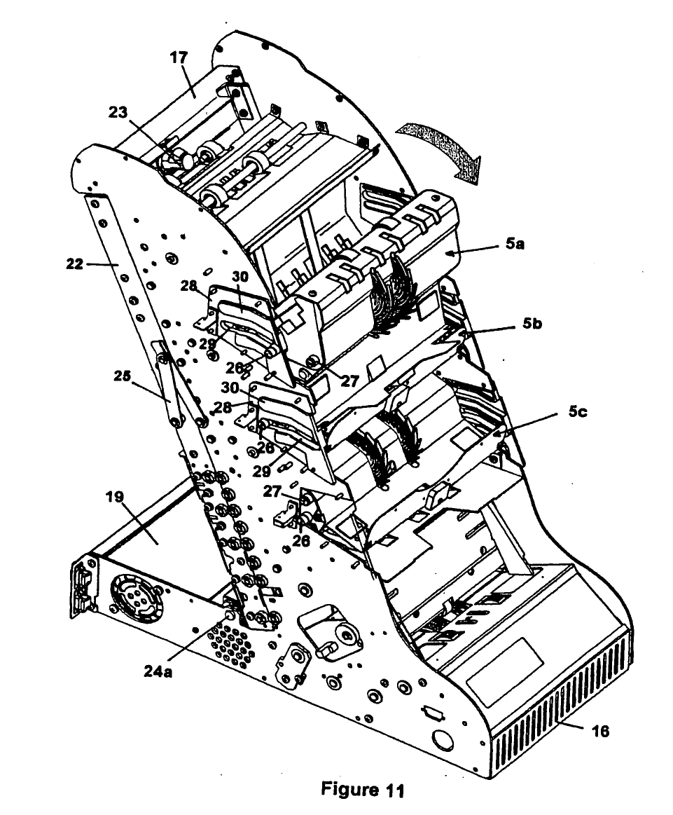

The second feature is illustrated in FIG. 11. In this, output pocket 5a is shown in a jam clearance position. Each of the output pockets 5a,5b,5c can be slid away from its normal position adjacent the transport belts by means of a guide system. Each pocket 5a,5b,5c is provided with a lower guide pin 26, and an upper guide pin 27 on each side of the pocket. The guide pins 26,27 support the pocket in support brackets 28 mounted on each of the right hand and left hand side plates 15a and 15b.

Each lower guide pin 26 is captive in a lower guide track 29 in the respective support bracket 28, and can run along the length of the track 29 such that the pocket 5a,5b,5c can be slid between normal and jam clearance positions. The track 29 limits the extent of motion of the guide pin 26.

Each upper guide pin 27 runs in an upper guide track 30 in the respective support bracket 28. However, the guide track 30 is open at its front end such that when pulled into the jam clearance position, the upper guide pin 27 can emerge from the upper guide track 30 allowing the pocket to tilt forward as shown for pocket 5a in FIG. 11. As can be seen, this allows access to the transport region behind the pocket 5a.

In a variant on this, the guide pin 26 is not captive in track 29, but can emerge from an open end of this. Similarly, guide pin 27 also can be withdrawn fully from guide track 30. Thus, the pockets may be removed fully when this variant is used.

Electrical connection to the pocket can be made in one of two ways. In a first method, cooperating connectors (not shown) are mounted on the pocket 5a,5b,5c and on the banknote sorter 1 such that the connectors make when the pocket is in its normal position and break when the pocket is pulled forward into its jam clearance position. The connectors are mounted such that they centralise with respect to each other when the pocket 5a, 5b, 5c is pushed into its normal position.

In a second method, a wiring loom (not shown) from the pocket 5a, 5b, 5c passes through a central opening in the guide pin 26. In this configuration, the guide pin 26 protects the wiring loom from abrasion or other damage as the pocket 5a, 5b, 5c is moved between the normal and jam clearance positions. A loop is provided in the wiring loom on the outside of the pocket 5a,5b,5c so that the cable is not placed under tension when the pocket 5a,5b,5c is in the jam clearance position.

In another variant, the pockets 5a, 5b, 5c have a single guide pin 31 on each side. The guide pins are captured in tracks 32. This is shown in FIG. 43. Latches (not shown) on the pockets 5a, 5b, 5c are operated to pull the pockets 5a, 5b, 5c forward.

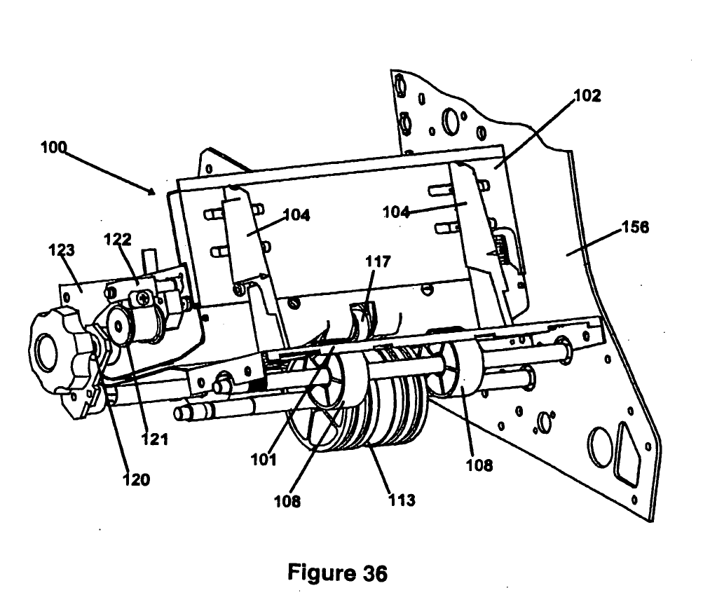

The third feature allows for jam clearance in the region of the feeder system 4, which is described below. The jam clearance is shown in detail in FIG. 36 which shows the hopper 100 and other parts of the feeder system 4.

As can be seen from FIG. 36, the hopper 100 comprises a base plate 101 and a back panel 102. The back panel 102 and other members of the feeder system 4 located above the base plate 101 are rotatable about a shaft 120 so that they may be separated from the base plate 101 and all members of the feeder system 4 below the base plate 101. This rotation of the back panel 102 exposes a gap between the members of the feeder system 4 above and below the base plate 101 thereby allowing retrieval of notes that have become jammed in that region.

In one variant the back panel 102 is held in its normal, operational position by means of a pair of latches, one on each side. However, in a preferred variant, a constant force spring 121 urges the back panel 102 and other members of the feeder system 4 above the base plate 101 towards the base plate 101. The constant force spring 121 is attached to a coupling member 122 which is attached in turn to a side member 123 on which the back panel 102 and other members of the feeder system 4 above the base plate 101 are mounted. A jam can thus be cleared simply by lifting the back panel 102 away from the base plate 101 and retrieving the jammed note.

The use of a constant force spring rather than a tension or torsion spring is advantageous since the resistance to movement of the back panel 102 is constant. This should be contrasted with a tension or torsion spring which will offer least resistance when the back panel 102 is in its operating position. This can lead to feeding of several notes at a time. Further, the resistance increases as the back panel 102 is moved away from the base plate 101. This can be annoying to a user attempting to clear a jam.

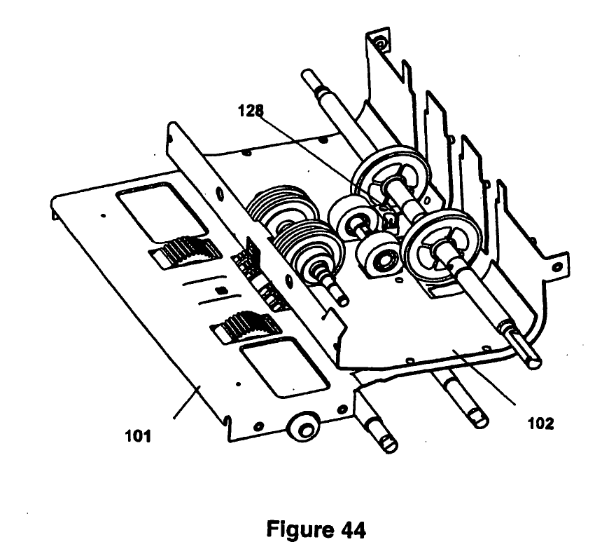

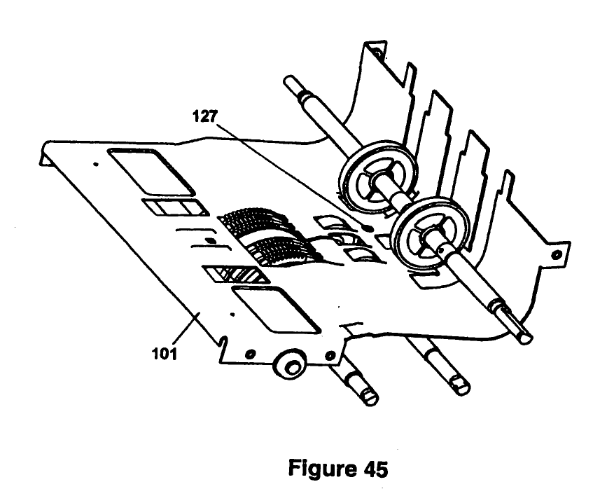

FIGS. 44 and 45 show cut-away views of part of the feeder system and transport system. In particular, they show the base plate 101 and back panel 102. A visible light emitter 128 is mounted on the back panel 102 and a corresponding receiver is mounted on base plate 101. These are used to detect the passage of documents between them, during which time the light emitted by emitter 128 will be obscured, and hence not detected by receiver 127.

The emitter 128 and receiver 127 undergo the same calibration process which is described later with respect to the other sensors provided in the transport system. However, as an extension of this process, the emitter 128 is caused to increase the intensity of light that it emits in inverse proportion to the amount received by receiver 127. Thus, when in the feeding position (as shown in FIG. 44), a large proportion of the light emitted by emitter 128 impinges on receiver 127. However, when these are separated as described above, the light emitted by emitter 128 no longer impinges on receiver 127 and the quantity of light emitted by emitter 128 is increased until it emits light at the maximum intensity of which it is capable. This light is used to illuminate a region of the document path between the base plate 101 and the back panel 102 to assist users in clearing jammed notes. The light is normally yellow in colour.

Feeder System

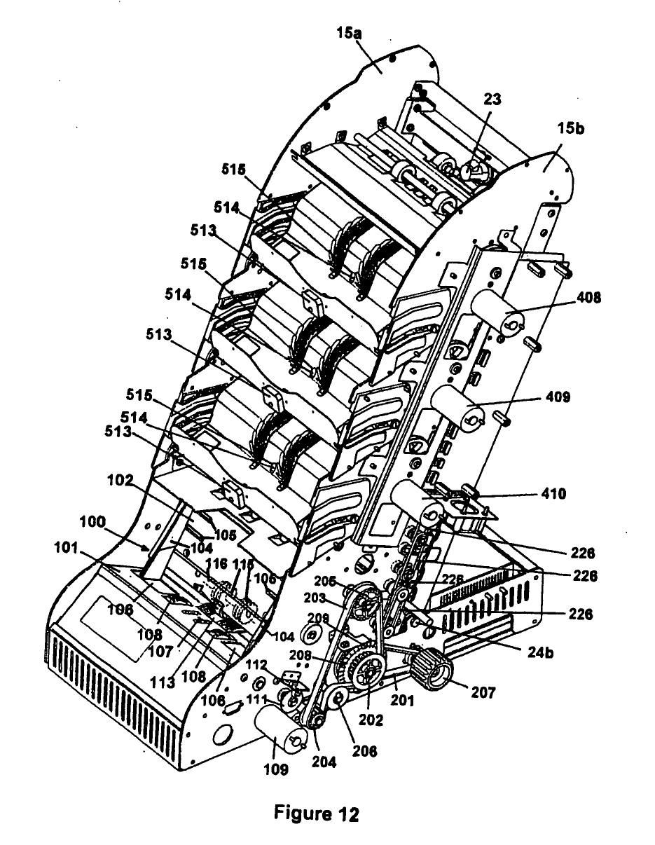

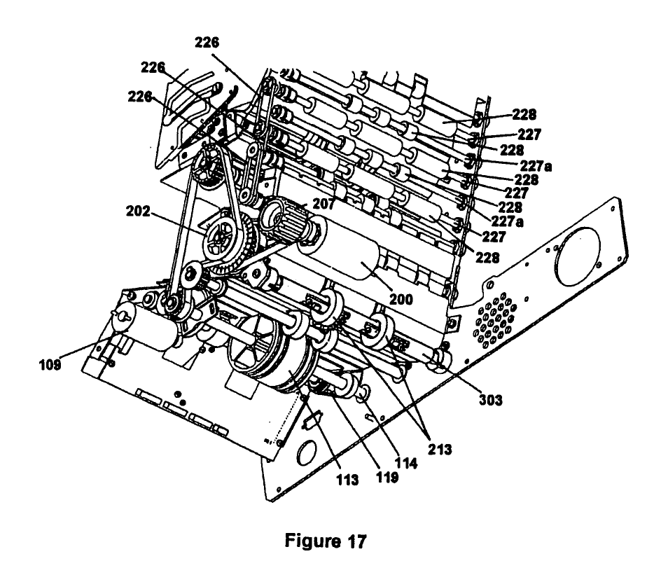

Banknotes are introduced into the banknote sorter 1 via a feeder system 4, which is best shown in FIGS. 12, 17 and 18.

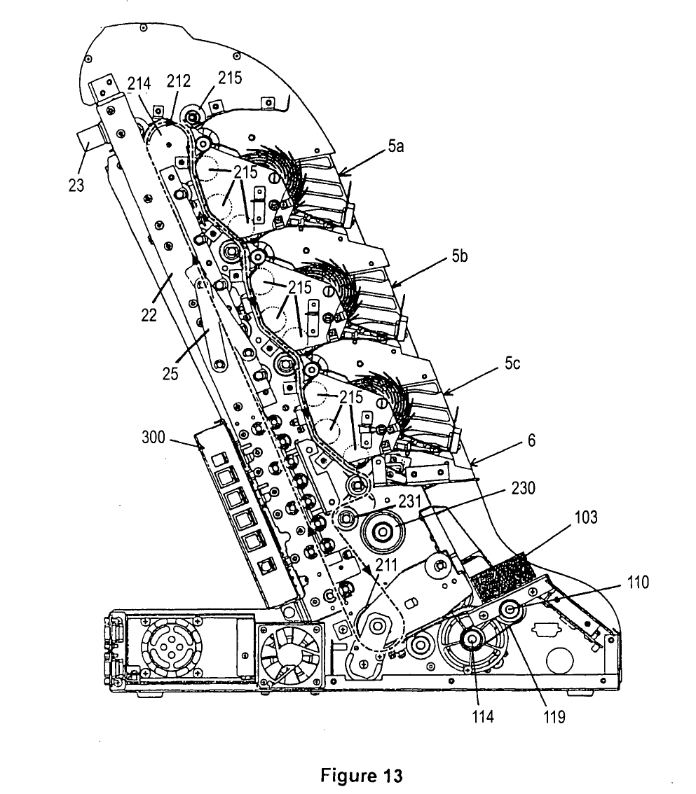

Notes to be sorted are placed as a stack in a hopper 100 defined by base plate 101 and back panel 102. For example, a stack of banknotes 103 is shown on the base plate 101 of hopper 100 in FIG. 13.

A pair of centralising guides 104 can be moved along the path defined by slots 105 until they are separated by the width of the banknotes to be sorted. The centralising guides 104 extend at their lower extremities into recesses 106 in the base plate 101 in order to prevent banknotes in the hopper 100 from sliding underneath them.

Each centralising guide 104 is connected to a respective rack gear (not shown) located behind the back panel 102. The rack gears extend towards each other in a widthwise direction of the back panel 102, and each meshes with a pinion gear (not shown) such that movement of one centralising guide causes the other to move by a corresponding amount. Therefore, adjusting the centralising guides 104 such that they are separated by the width of the banknotes to be sorted ensures that the banknotes are centralised in the hopper 100.

Markings may be provided on the back panel 102 to indicate to which position the guides 104 should be moved in order to provide the correct spacing for particular denominations. Since movement of one guide 104 causes a corresponding movement of the other different markings can be provided adjacent each guide 104. For example, the left hand guide 104 may have,5 and, 20 markings provided on the back panel 102 whilst the right hand guide 104 has, 10 and, 50 markings.

The presence or absence of notes in the hopper 100 is detected by means of visible or infra-red radiation emitted by an emitter (not shown) that passes through an aperture 107 in the base plate 101. If a note is present then a portion of the emitted radiation is reflected by the banknote back through aperture 107 and is detected by a corresponding detector (not shown). If no banknote is present then the radiation is not reflected. The detection of a banknote may be used to automatically activate the feeder system 4 and sort the banknotes.

Notes are fed into the banknote sorter 1 from the bottom of a stack by nudger wheels 108. These nudger wheels 108 have ribbed portions that extend outward radially beyond the radius of the remainder of the circumference of the nudger wheels 108 through cut-outs in the base plate 101. When the nudger wheels 108 rotate, the ribbed portions periodically protrude through slots in the base plate 101. The lowermost banknote is gripped by the ribbed portions and forced into the banknote sorter 1. The nudger wheels 108 are driven by a DC motor 109 which is operable, on application of a forward polarity excitation, to cause a shaft 110, on which the nudger wheels 108 are mounted, to rotate. A slotted disc 111 is mounted at one end of the shaft, and is arranged such that the slot passes through an optical detector 112 mounted on the left hand side plate 15b of the banknote sorter 1 just after the nudger wheels 108 have moved past the recesses in the base plate 101. The rotational position of the nudger wheels 108 can therefore be monitored by this.

When the last of a batch of notes to be fed is picked up by the nudger wheel 108, the absence of notes will be detected, as already described. A motor controller (described later) will then cause the motor to come to rest (this may also happen as a result of a decision to cease the feeding of documents for some reason) by applying a reverse polarity excitation to motor 109 when the detector 112 next detects the passage of slot 111. The reverse polarity excitation is applied for a predetermined time, and this causes the motor 109 to brake. This predetermined time period is sufficiently long to brake the motor efficiently without causing it to rotate in reverse. The braking period is sufficiently long for the last note to clear the feeder system 4 before the motor 109 stops. Normally, the excitation is then removed from the motor, but it is also possible to apply a lower magnitude reverse excitation to lock the motor so as to positively prevent it from turning, even by application of external force. The lower magnitude reverse excitation is insufficient to cause the motor to rotate.

The stop position of the feeder system 4 may be selected such that the feeder wheel 113 undergoes nearly a whole revolution before engaging the first note of a new batch to be fed. This allows it to accelerate fully. The position of the wheel 113 can be determined from detector 112 and slot 111.

Banknotes fed by the nudger wheels 108 are subsequently fed by a feeder wheel 113 into the transport system. The feeder wheel 113 is mounted on a shaft 114 that is driven via a drive belt 119 from the nudger wheel shaft 110. The feeder wheel 113 has a high friction, ribbed, rubber insert provided along an arcuate portion of the circumference of the wheel 113 that grips each note and drives it forward to the transport system.

A pair of counter rotating separator rollers 115 acts in co-operation with the feeder wheel 113 to prevent more than one note being fed into the transport system at a time.

The separator rollers 115 are mounted on a shaft 116 that is supported in the side plates 15a, 15b. The shaft 116 is driven in the opposite rotational sense to the shaft 114 on which the feeder wheel 113 is mounted. Therefore, if two notes are fed to the feeder wheel 113 the counter-rotating separator rollers 115 will push the topmost note backwards relative to the lowermost note and thereby prevent it from entering the transport system. Ridges in the separator rollers 115 correspond with grooves in the feeder wheel 113, and vice-versa. This causes notes fed between them to adopt a wave profile, and this has been found to improve feeding performance.

The shaft 116 is driven by a forked component (not shown) that is periodically nudged by an eccentrically-mounted roller (not shown) attached to the feeder wheel shaft 110. The forked component is coupled to the shaft 116 via a one-way clutch (not shown). Due to this coupling arrangement the separator rollers 115 rotate slowly and the rollers 115 wear evenly.

The gap between the separator rollers 115 and feeder wheel 113 is adjusted using a thumb wheel 118 (see FIG. 5). Turning the thumb wheel 118 causes an eccentric cam (not shown) to rotate which in turn adjusts the separation between the separator rollers 115 and feeder wheel 113.

A dolly roller 117 is rotatably mounted on shaft 116 between the two separator rollers 115, and rests on a centre portion of the feeder wheel 113. A second dolly roller (not shown) also rests on the feeder wheel 113, but at a position to the rear of the separator rollers 115. It is spring loaded against the feeder wheel 113. The dolly rollers co-operate with the feeder wheel 113 and separator rollers 115 to prevent more than one note being fed at a time, and to prevent notes overlapping.

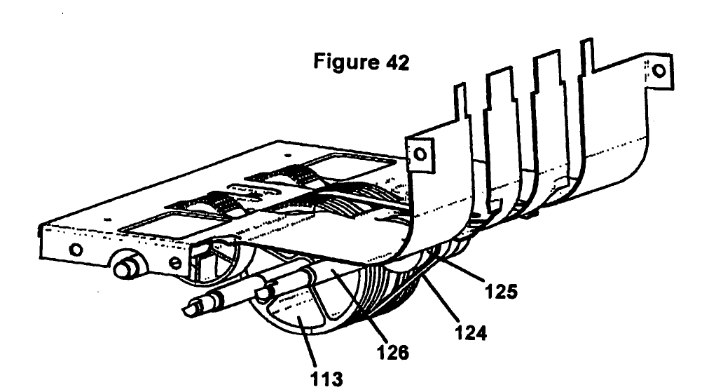

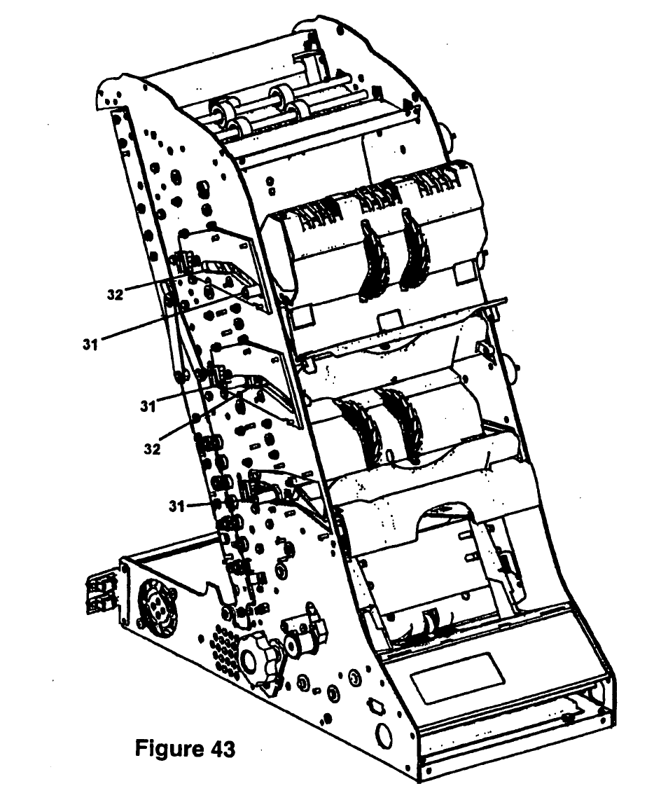

It has been found that the feeding of limp notes can be problematic since their leading edges tend to follow the feeder wheel 113 rather than be fed into the transport. A means of overcoming this is shown in FIG. 42. In this, a belt 124 is entrained around a central recess of the feeder wheel 113 and a corresponding roller 125 mounted on shaft 126. The belt 124 is arranged to be just beneath the surface of the feeder wheel 113 at points where they contact. However, as can be seen the belt 124 will prevent notes from following the feeder wheel 113 as it rotates. Instead they will be fed into the transport.

Transport System

The transport system is best shown in FIGS. 12, 13 and 18.

The transport is driven by a DC motor 200, the output shaft of which is coupled via a first toothed drive belt to a toothed drive pulley 202. A second toothed drive belt 203 is coupled with the drive pulley 202 and also extends around a tensioning pulley 204, a second drive pulley 205 and a third drive pulley 206.

The tensioning pulley 204 is mounted on a stub axle attached to a sub-plate (not shown). The sub-plate is fastened to side plate 15b by a screw passing through a slot in the sub-plate. This allows the sub-plate to be moved relative to the side plate 15b, and the tension in the drive belt 203 can be adjusted.

A hand wheel 207 is connected to the output shaft of DC motor 200. This hand wheel 207 can be used to operate the transport manually which may be useful in order to move notes to a position where they are accessible during clearance of a jam.

An array of slots 208 is provided around the periphery of the toothed drive pulley 202 and these pass through an optical detector 209 as the pulley 202 rotates. The optical detector 209 detects the passage of each of the slots 208, and corresponding pulses are output by the optical detector 209. These pulses can be used to provide a timing signal which in turn can be used to determine the position of a banknote as it passes through the transport system. The position of the notes between timing pulses can be interpolated to provide a finer resolution.

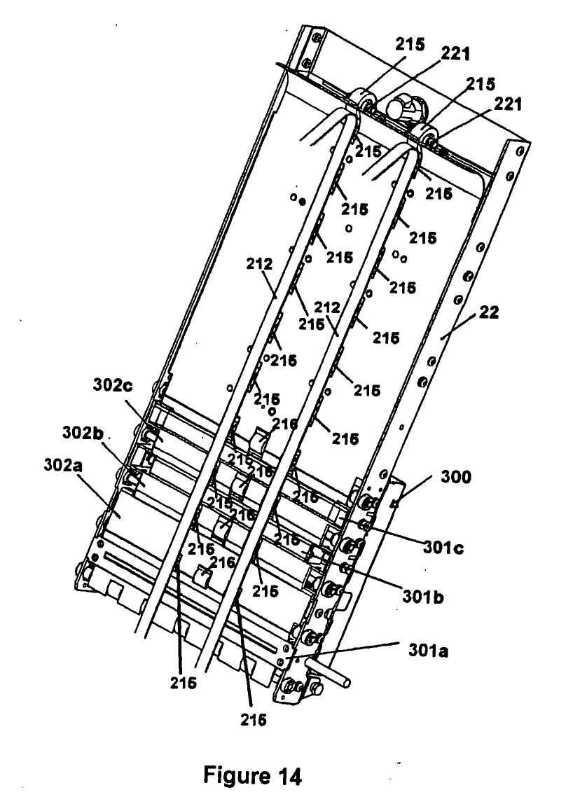

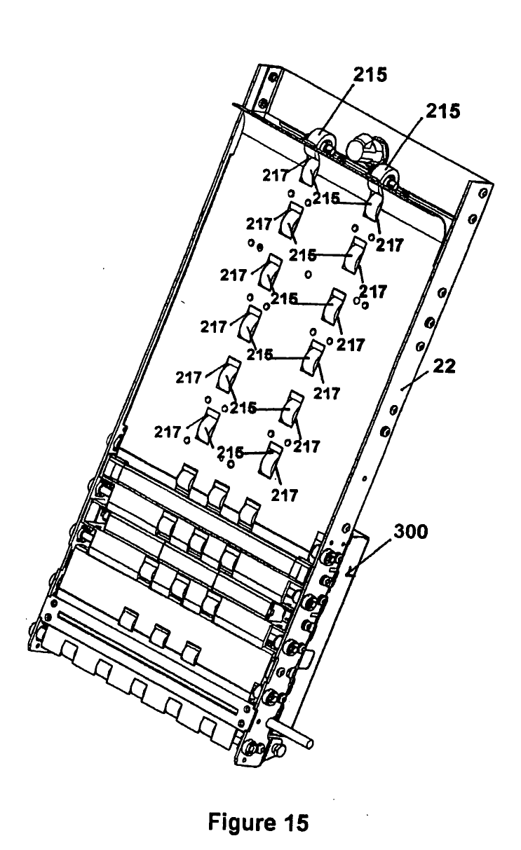

The toothed drive pulley 202 is mounted at one end of a drive shaft 210 that is supported in bearings in each of the left hand and right hand side plates 15a,15b. A pair of transport belt pulleys 211 are mounted on the drive shaft 210. The two pulleys 211 are spaced apart and each is used to drive a respective transport belt 212 (see FIG. 14). Banknotes that are supplied by the feeder system 4 are urged forward by a pair of rubber rollers 224 mounted on a shaft 225 driven by the third drive pulley 206. They are then gripped between the transport belts 212 and a pair of pinch rollers 213 which co-operate to pull the notes into the transport system.

The path of the transport belts 212 is shown in the cross-sectional view of FIG. 13. As can be seen, each transport belt 212 forms an endless loop between the transport belt pulleys 211 and the top belt pulleys 214. Notes fed into the transport from the feeder system 4 are conveyed by the belts 212 past the detector system 300 and can then be diverted from the transport by any one of the three diverters into the respective output pocket 5a, 5b or 5c. Any notes that are not diverted are automatically placed in the cull pocket 6.

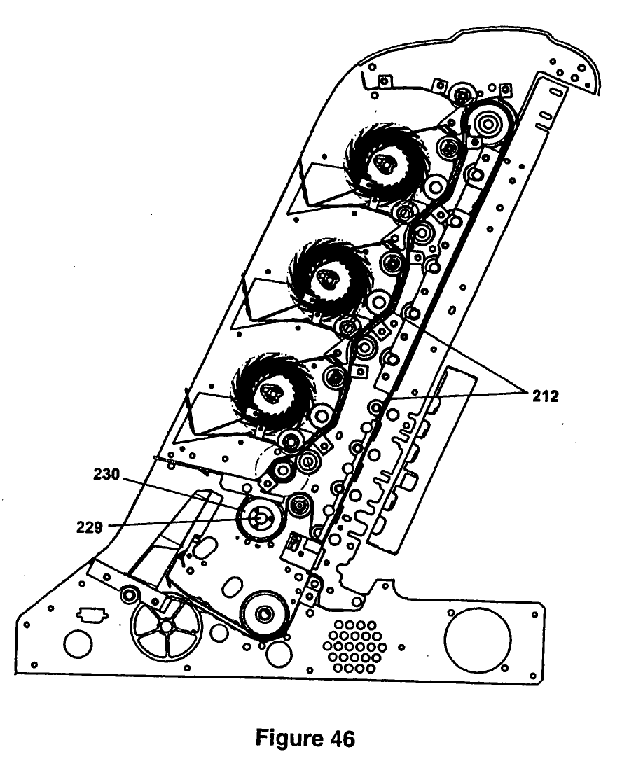

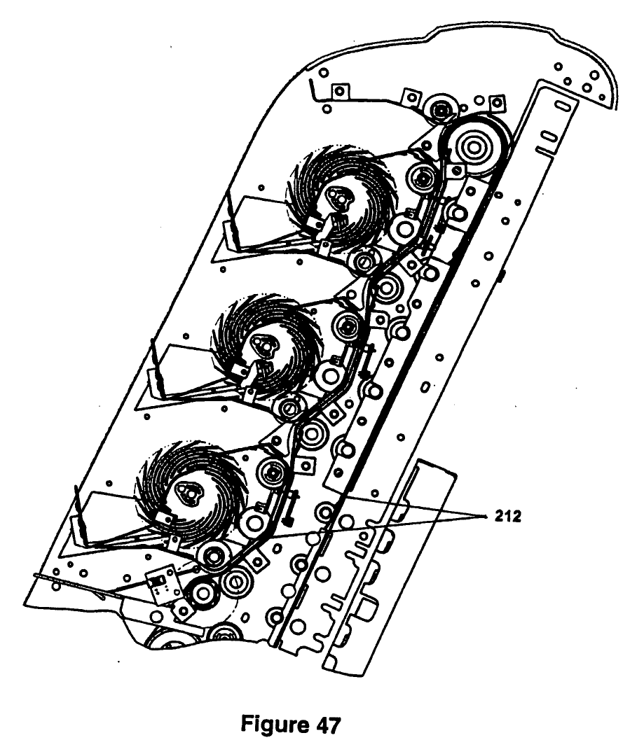

In an alternative embodiment, shown in FIGS. 46 and 47, the drive belts 212 do not extend around pulleys 211, but instead extend around and are driven by pulleys 230 mounted on the shaft 229 on which the third drive pulley 206 is mounted. In this embodiment, the belts 212 loop around pulleys 230 in a clockwise direction and then rollers 231 in a counterclockwise direction. The belts 212 then rejoin the path shown in FIG. 13 by looping around the roller 228 adjacent to the lowermost set of rollers 228. The pulleys 211 simply advance the note via one or more guide plates (not shown) to the lowermost set of rollers 228, which is described below, and is driven by the transport belts 212. The lowermost set of rollers 228 advance the note to the detector system 300 and into the transport belts 212.

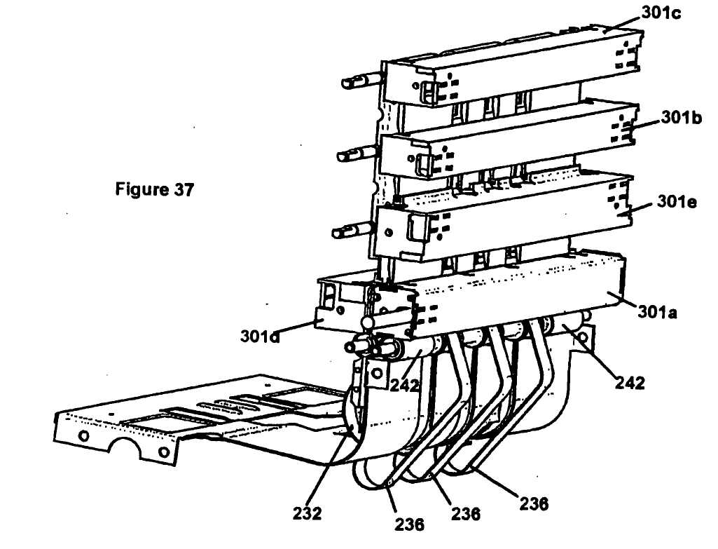

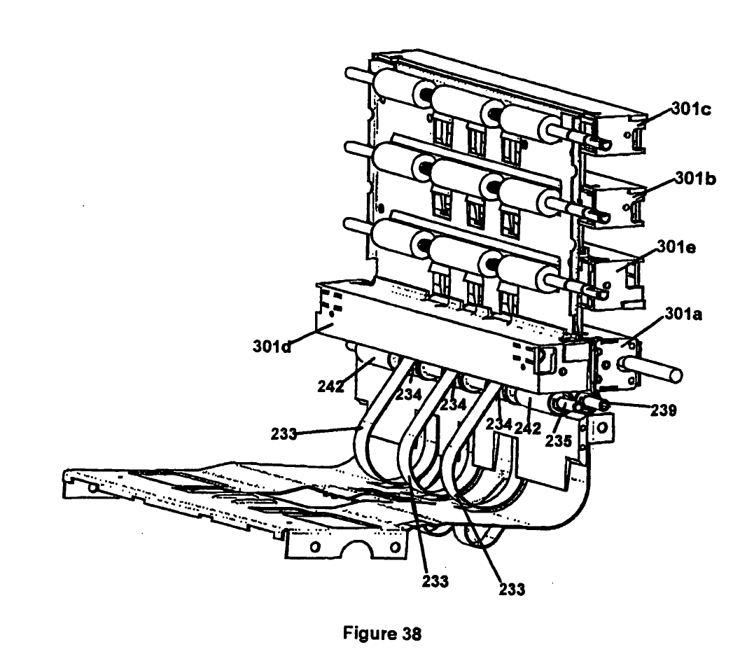

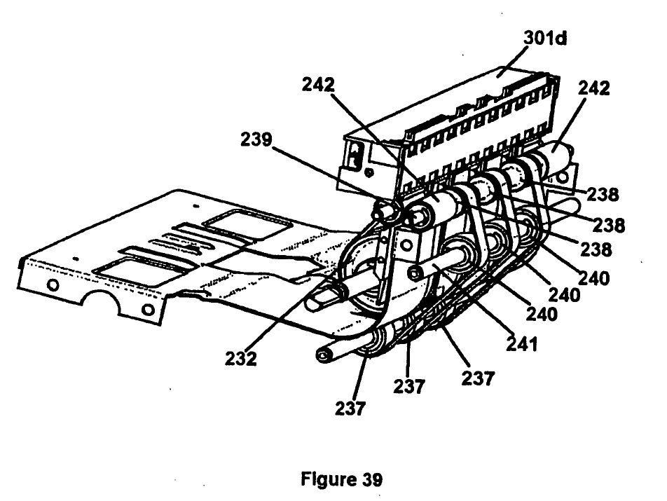

FIGS. 37 to 39 show an improvement to the transport that may be used with this alternative embodiment. This improvement improves note handling between the feeder system 4 and the detector system 300.

In this improvement, the pulleys 211 are replaced by three pulleys 232. Three belts 233 are entrained around respective ones of the pulleys 232 and rollers 234 disposed on shaft 235.

Three further belts 236 are entrained around the three pinch rollers 237 (which replace pinch rollers 213), rollers 238 mounted on shaft 239, and rollers 240 mounted on shaft 241.

As can be seen, the corresponding ones of the belt 233 and 236 follow adjacent paths for part of their lengths and guide the notes between the feeder system 4 and the detector system 300.

Outboard rollers 242 are provided at each end of the shafts 235 and 239 to improve control of the edge of the notes as they are fed into the detector system. Typically, a gap of 0.5 mm is set up between the rollers 242 in order to ensure good note guidance into the detector system, which normally has a 1 mm gap. The rollers 242 are typically steel. However, they may be made from a compliant material such as a polymer or rubber. The rollers 242 can then be positioned to form a pinch with the purpose of guiding notes into the detector system.

The shafts 235 and 239 supporting the belts 233 and 236 may be spring mounted (not shown) so as to hold the belts in their normal positions (as shown) during operation whilst permitting a user to displace the belt assembly thereby gaining access to the transport path for jam clearance. However, the provision of belts 233 and 236 has improved note transport to the extent that jams are rare. Therefore, as a cheaper alternative, the mounting may be fixed and jammed notes removed by winding the transport belts using handle 207 so as to carry the jammed note to a point from which it may be retrieved. The detector system 300 is provided with eight shafts 227, 227a on which rollers 228 are mounted. The shafts 227 are all coupled by O-rings 226 such that they all rotate in sympathy. The shafts 227a are simply supported in bearings such that they may rotate freely. The lowermost two shafts 227 are coupled by two O-rings 226 due to the extra torque that must be transmitted between these two shafts. The use of O-rings to drive these rollers is sufficient since the rollers simply guide the notes, which are driven by belts 212. Thus, the rollers can slip relative to the note with no serious consequences.

These rollers 228, in conjunction with the rollers 215, ensure that the note maintains good contact with the detectors in the detector system. The shafts 227 are driven by the transport belts 212, and by virtue of the O-rings 226 coupling shafts 227 the note is driven at a constant speed through the detector system 300 even if it slips relative to the belts 212.

Pinch rollers 215 are provided adjacent each transport belt 212 along its path between the transport belt pulleys 211 and the cull pocket 6. Each pinch roller is positioned at a distance from the adjacent pinch rollers 215 that is less than the width of the smallest banknote that the banknote sorter 1 is required to handle. As such, a banknote is always engaged between at least one pair of pinch rollers and the pair of transport belts 212.

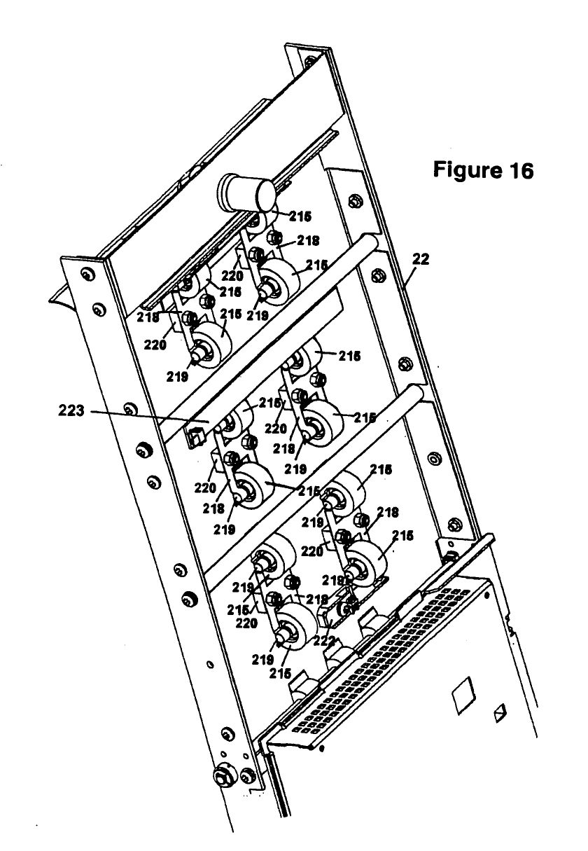

Between each pair of pinch rollers 215 in the vicinity of the detector system 300, there is also provided a central roller 216. Each of these pairs of pinch rollers in the vicinity of the detector system 300 and the corresponding central roller 216 are mounted on a respective shaft (see FIG. 16) that is supported at each end in the sides of the rear access cover 22.

The six pairs of pinch rollers 215 downstream from the detector system 300 are supported in so-called H-springs 218 (as shown in FIG. 16). The H-springs 218 are fabricated from spring steel and large the pinch rollers 215 against the transport belts 212 through apertures 217 in the rear access cover 22. Each of the pinch rollers 215 is shown mounted on a respective shaft 219 that is securely gripped by the H-spring 218. Each H-spring 218 is mounted on the rear access cover via a spacer block 220 to provide the correct spacing of the central axis of the pinch rollers 215 from the transport belts 212.

Another arrangement is where a single shaft is suspended by a single, central H-spring 218 and the shaft has pinch rollers 215 mounted on its corresponding left and right hand ends.

In yet another embodiment, the H-springs 218 are replaced by coil springs that act on the shafts 219 to urge the rollers 215 towards the transport belts 212.

The topmost pinch rollers 215 provided in the access cover are mounted on the access cover by means of a spring clip 221. The spring clips 221 are manufactured from spring steel.

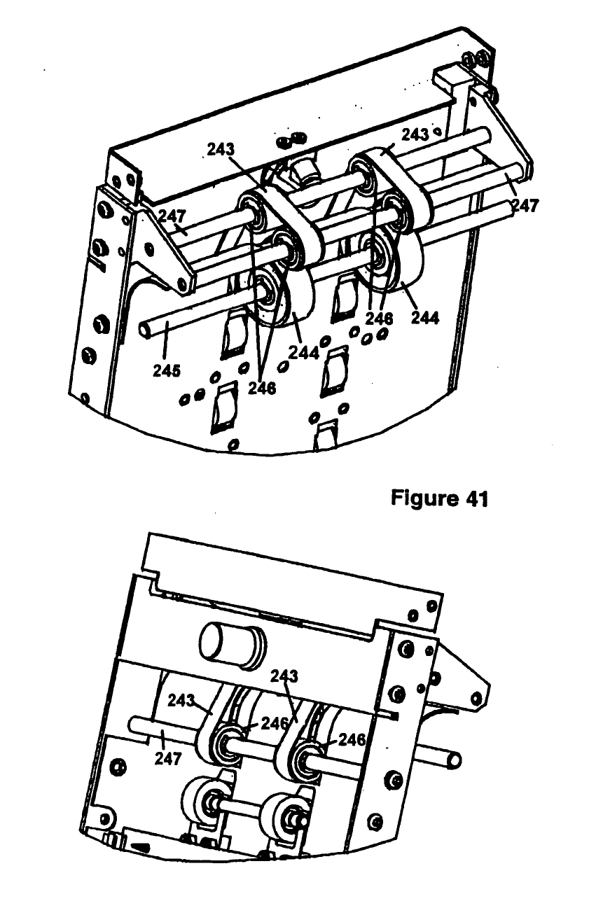

Another embodiment is shown in FIG. 41. This shows an alternative mechanism for guiding notes around the top of the machine. In this mechanism, notes are fed into a pinch between belts 243 and rollers 244 mounted on shaft 245. The belts are entrained about rollers 246 mounted on shafts 247. This mechanism provides accurate note guidance around the top of the machine.

Each output pocket 5a,5b and 5c has three pairs of pinch rollers 215 provided in its rear surface such that they engage the transport belts 212 when the output pockets 5a,5b and 5c are in their operational positions.

The transport is provided with a pair of sensors that are used to detect the passage of notes past respective points along a transport. The first of these is known as the post-detect sensor 222. This is an optical sensor that comprises a visible light or infrared emitter and a corresponding detector. The sensor may work on either a transmissive or reflective principle. In the transmissive system, the detector and emitter are spaced such that a note passing along a transport will interrupt the beam of radiation emitted by the emitter and detected by the detector. In the reflective system the passing note reflects radiation emitted by the emitter such that it is detected by the detector. In both cases, the emitter and detector may be provided with glass or plastic windows that are wiped clean of dust by passing notes. The amount of current supplied to the emitter may be automatically and periodically adjusted when no document is present to ensure reliable operation.

This technique may be used to compensate for the presence of dust that has not been removed by the passage of notes on the windows, or to compensate for an emitter whose light output is diminishing with age, or where the detector=s sensitivity changes with age.

The second sensor is known as the pre-divert sensor 223 and this works on exactly the same principle as the post-detect sensor 222.

These sensors allow the position of a note at two discrete points in the transport to be ascertained. The position of a note can then be extrapolated from these two fixed positions using the array of slots 208 and optical detector 209 as mentioned earlier.

Other sensors of a similar nature may be provided after each diverter (not shown) to detect whether a note has been successfully diverted from the transport into the output pocket. Such sensors may also be used to confirm that a note that was not to be diverted has arrived at that position when predicted.

In fact, the sensors provided after each diverter may also be used to confirm that a note that was to be diverted has been successfully diverted. For example, if the note is not detected by the sensor associated with a specific diverter after a predetermined time has elapsed, it may be assumed that the note has been successfully diverted. This predetermined time may be started when the note passes an upstream sensor (for example, one associated with an upstream diverter or the pre-divert sensor). This time may be adjusted in accordance with the speed of the transport, with higher transport speeds correspondingly reducing the predetermined time. If the sensor associated with a diverter does detect the presence of a document that should have been diverted, the transport may be stopped so that a user may intervene.

The position of a note in the transport may be predicted using the array of slots 208 and optical detector 209. If the post-detect or pre-divert sensors 222,223 do not confirm the presence of the note at the correct time (within a predefined tolerance) then a jam may be indicated to the user and the transport stopped.

The predicted position of a note or document may take account of the degree of slip which that type of note or document experiences with respect to the transport. The predefined tolerance may similarly be varied for different types of document.

The amount by which a note slips between the two sensors 222 and 223 may be used to predict the amount of slip elsewhere in the transport, if it is not sufficient to cause a jam to be indicated.

Furthermore, the amount of slip can be used to provide a measure of how crumpled a note is, and this can be used to categorise or sort a note.

In another embodiment, more than one sensor is provided at the post-detect and pre-divert positions. These sensors are spaced laterally across the banknote sorter 1. False detection or failed detection can then be avoided by monitoring all sensors. The presence of a skew note can also be detected since the note will be detected by one sensor before being detected by an adjacent sensor. This also assists in actuation of the diverters in good time when a note is skewed since the note will generally still be detected by one of the outboard sensors of the transport before it is detected by the central sensor.

The guides used in parts of the transport are made from plastics, as this inherently reduces the noise by virtue of its damping capabilities.

Detector System and Doubles Detector

The detector system 300 comprises a plurality of different detectors. These may include infra-red, visible light, ultraviolet and magnetic detectors. A signal processing PCB receives signals from the individual detectors and can be used to derive a set of characteristics for each banknote that passes through the detector system 300. These characteristics may include the currency and denomination of the banknote, the authenticity, its orientation and facing, and state of wear of the banknote. In addition, the detector system may be provided with an interface (for example, a CAN bus interface) to third-party detectors.

FIG. 14 shows three detectors 301a, 301b and 301c. These are mounted in respective metal casings, each of which has a respective flange 302a, 302b and 302c extending from it that acts as a guide for banknotes passing through the detector system 300. An advantage of integrating the flanges 302a, 302b and 302c with the housings for the detectors 301a, 301b and 301c is that the flanges and detectors can be simultaneously adjusted with respect to the transport belts 212.

In one embodiment, the detector 301a is a contact image sensor. This type of sensor is responsive to infrared radiation transmitted through the note by an infrared source (not shown), and to visible light emitted from the sensor itself and reflected by a banknote. From the reflected visible light, the note=s pattern characteristics (i.e. the image on the note) and the degree of soil may be detected. In addition, a second contact image sensor 301d (shown in FIGS. 37 to 39) may be provided on the opposite side of the transport to detector 301a. This is particularly useful where a note=s pattern cannot be used to determine its denomination unless it is also determined which way round the note is facing in the transport (i.e. which face is outermost and which is innermost). Such is the case, for example, with Indian currency, but providing opposed contact image sensors allows determination of the note=s denomination and face orientation.

In addition, the detectors 301a to 301e may comprise a magnetic thread pattern detection system, such as Superior Magnetic Detection System (SMDS). Typically, this will be detector 301b. Such a system is described in published European patent applications EP1221679A, EP1353302A, and EP1353301A, which are incorporated herein by reference. Furthermore, they may comprise a sensor responsive so as to detect so-called composite notes. These are notes that are manufactured by a counterfeiting operation by joining together very thin slivers taken from other genuine notes to form a counterfeit note.

In addition or instead, the detectors 301a to 301e may comprise one or more of the following detectors: a reflected ultraviolet paper properties detector; a reflected visible light contact image sensor and a transmitted infrared contact image sensor (for example, detector 301a may be the infrared emitter and detector 301d may be an infrared receiver).

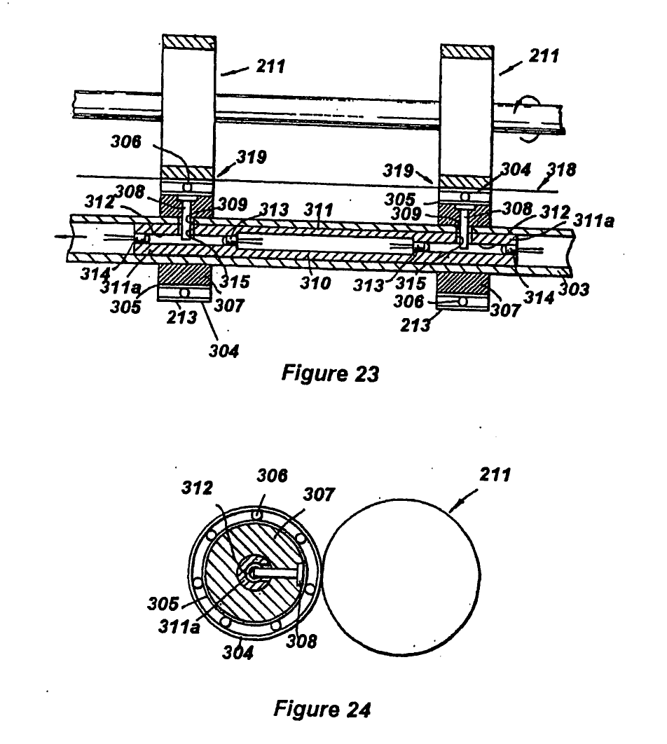

The banknote sorter 1 is equipped with a thickness detector, also known as a doubles detector, that is used to detect the passage of two notes simultaneously through the transport, which may occur if the separator function previously described is not effective. The doubles detector is shown in detail in FIGS. 23 and 24.

The transport belt pulleys 211 and pinch rollers 213 define sheet sensing apparatus for detecting the passage of two or more notes simultaneously and for counting banknotes. Alternatively, separate conventional counting means may be used. The transport belt pulleys 211 and pinch rollers 213 are spaced apart by a distance less than the width of sheets being counted.

The shaft 303 is hollow, is non-rotatably supported by the side plates 15a, 15b and carries the two pinch roller assemblies 213. These are identical in construction and each contacts a respective one of the transport belt: pulleys 211.

Each roller assembly 213 comprises a roller bearing having an annular outer race 304, an annular inner race 305 and bearings 306 positioned between the inner and outer races. The bearing is mounted coaxially about the shaft 303 on an annular rubber portion 307. A metal pin 308 abuts the radially inner surface of the inner race 305 and extends through the rubber portion 307 and an aperture 309 in the shaft 303 into the shaft.

A moulded plastics housing 310 is mounted within the shaft 303 and comprises a central tubular portion 311 integral with end portions 311a each of which has a bore 312 communicating with the tubular portion 311. A pair of light emitting diodes 313 are mounted in the inner ends of the bores 312 while a pair of phototransistors 314 are mounted at the outer ends of the bores 312. For clarity, only portions of the connecting wires from the light emitting diodes 313 and the phototransistors 314 have been illustrated. In fact, these wires will pass along and out of the shaft 303 to monitoring circuitry mounted on the detector system PCB, and described below. To facilitate assembly all wires extend from the same end of the shaft 303. Each portion 311a of the housing 310 also has an aperture 315a communicating with the bores 312 and in alignment with the aperture 309. The pins 308 extend through the apertures 315 into the bores 312.

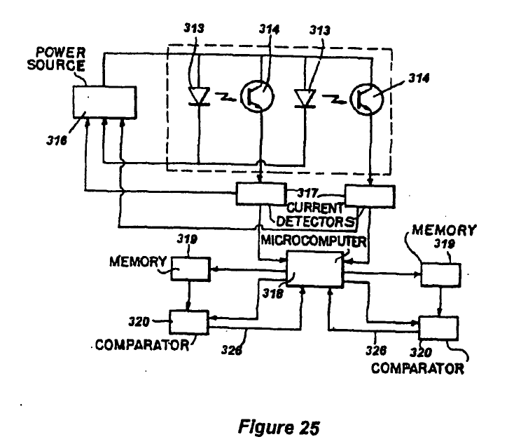

The circuitry is illustrated in detail in FIG. 25 illustrates the two light emitting diodes 313 and the phototransistors 314 each of which is connected to a power source 316. The section of the circuit shown enclosed in dashed lines is that section mounted in the plastic housing 310. The output from each phototransistor 314 is fed via respective current detectors 317 back to the power source 316. The output from the detectors 317 is fed to a microcomputer 318. The microcomputer 318 causes signals from the detectors 317 to be routed to a selected one of a respective pair of a memory 310 and comparator 320. The outputs from the comparators 320 are connected to the microcomputer 318.

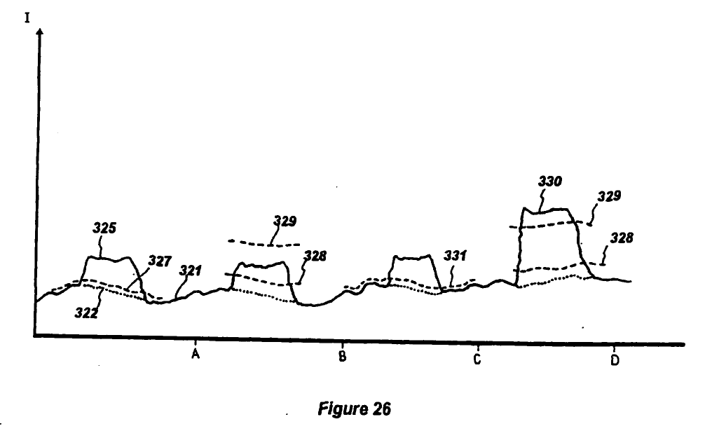

Initially, the transport belt pulleys 211 are rotated and with no banknote present between the pulleys 211 and pinch roller assemblies 213, any deflection of each roller assembly 213 accompanied by compression of respective rubber portions 307 adjacent the pulleys 211 will be sensed in a manner to be described at forty equally spaced intervals through one revolution of the roller assemblies 213. Compression of each rubber portion 307 in a radially inward direction will be accompanied by radially inward movement of each pin 308. Each LED 313 continuously emits light which impinges on respective phototransistors 314 causing them normally to be partially switched on. If a pin 308 moves radially inwardly, the pin 308 will increasingly obscure the path of light rays from the LEDs 313 to the phototransistors 314 thus increasing the amount by which the phototransistors 314 are cut off. The output (I) from the phototransistors 314 is fed to the current detectors 317 which provide an output representative of the respective collector current. Under control of the microcomputer 318 these outputs are sampled at forty equally spaced positions around the pulleys 211 (which will be determined by monitoring the passage of slots 208 through optical detector 209). The sampled current values are then stored in the respective memories 319 as a guide surface profile. A typical output detected by the current detectors 317 is illustrated by a line 321 in FIG. 26. The forty sampling positions occur between the origin of the graph in FIG. 26 and the position marked A and the guide surface profile comprises that portion of the line 321 up to the position A and including the dotted portion 322. FIG. 26 illustrates the output from the current detectors 317 over a number of revolutions of the roller assemblies 213 and it will be seen that the guide profile comprising the line 321 and the dotted portions 322 is generally the same in each portion OA, AB, BC and CD.

Each LED 313 continuously emits light which impinges on respective phototransistors 314 causing each phototransistor 314 to pass collector current at an initial level. Each pin 308 normally partially obscures the light path. When a banknote 323 is presented to the nip 324 between the transport belt pulleys 211 and the respective pinch roller assemblies 213, the banknote 323 will be taken up and transported through the nip 324 and each rubber portion 307 will be compressed radially inwardly due to pressure exerted from the outer race 304 via the bearings 306 and the inner race 305. This movement will also be accompanied by a radially inward movement of each pin 308, which will thus further obscure the path of light rays from the LEDs 313 to the phototransistors 314 thus further attenuating light transmitted to the transistors 314.

The microcomputer 318 continually samples the output signals from the detectors 317 at the same forty equally spaced intervals but routes these instead to respective comparators 320. An example of a set of output signals caused by the presence of a single note in the nip 324 is illustrated by a line 325 in FIG. 26. It will be seen that part of the line 325 is the same as the line 321 but that over a portion of the sampling region OA it is substantially different. The comparators 320 compare successively the forty values with the corresponding forty values stored in the memory 319 and generate an output on a signal line 326 (see FIG. 25) related to the difference between the values which is fed back to the microcomputer 318. As is to be expected from a banknote with a substantially constant thickness the difference between the signals represented by the line 325 and the corresponding portion 322 of the stored profile is substantially uniform.

The signal on the lines 326 is then compared by the microcomputer 318 with a previously stored threshold which has been set at a relatively low level. This is indicated by a dashed line 327. When this threshold has been exceeded at a number of the sampling positions (normally less than forty since the length of the banknote is generally shorter than the pulley 211 circumference) it is assumed that a banknote has passed through the nip 324. If the presence of a banknote is detected by both phototransistors 314 then the microcomputer 318 increments a count value by 1. In addition, the threshold is modified (usually increased) so that it represents the difference between the detector output and the stored profile corresponding to a note having half the thickness of the note detected. Other fractions than one half could also be used. A line 328 illustrates a detector output at the new threshold.

For subsequent banknotes, this new threshold is used and the steps repeated. Each time a banknote is detected the count value is incremented by one. FIG. 26 illustrates the detection of single banknotes during successive rotations of the pulleys 211 in the periods OA, AB, and BC.

In addition, the microcomputer 318 determines whether the detector output signals indicate a thickness greater than a threshold 329 representing one and a half times the thickness of a single note which suggests the passage of two banknotes through the nip 324 simultaneously. In this case, the microcomputer 318 would cause an error message to be displayed on the display 11 and additionally could cause the banknote sorter 1 to stop. An example of such an output from the detectors 317 is illustrated by a line 330.

With typical materials, it is unlikely that two successive full rotations of the pulleys 211 and pinch rollers 213 will cause the phototransistors 314 to provide exactly similar outputs due to dirt coming off the notes. Thus, for example, even when no note is present in the nip 324, a subsequent output sensed by the current detectors 317 might have the form shown by a line 331 in FIG. 26. After sampling and comparison under the control of the microcomputer 318, however, the microcomputer 318 would determine that the difference between the detector output and the stored profile did not exceed the threshold and thus the microcomputer 318 would not consider that the passage of a note had occurred.

Additionally, over a period of time, the output from the detectors 317 may change significantly, that is by an amount similar to that which would be expected from the passage of a note. In order that the apparatus can still function, the microcomputer 318 causes a new profile to be stored by the memories 319 instead of the previously stored profile 321,322 just before a new stack of banknotes are sorted. In this way, the threshold which must be initially determined by the microcomputer 318 is automatically corrected for changes in profile.

In some cases, a folded note may be passed through the apparatus in which case the microcomputer 318 will pass signals to one of the comparators 320 which may indicate the presence of a note 323 while the signals passed to the other comparator 318 will suggest that no note is present. The microcomputer 318 can detect from the signals passed to it along the lines 326 that they represent different differences and in such a case can cause the display 11 to indicate an appropriate error message.

The microcomputer 318 can also be programmed to be able to detect half notes as well as folded notes, and notes which have been fed in a skewed manner. In addition, one important feature is that the length of notes fed can be determined. Where the output from the phototransistors 314 is monitored at eight or more positions a progressively more accurate determination of the length of a note being fed can be achieved. This is particularly useful since it provides a non-time dependent method of measuring note length.

As has been previously explained, the LED's 313 and phototransistors 314 are mounted in a moulded plastics housing 310 and this is slidable into and out of the shaft 303. In order to assemble the apparatus, the housing 310 together with the LEDs 313 and phototransistors 314 is pushed into the shaft 303 until the apertures 309 and 315 are in alignment. The rubber portions 307 are then mounted about the shaft 303 and each pin 308 is then slotted through the rubber portions 307 and the apertures 309 and 315. Finally, the inner and outer races 305 and 304 and bearings 306 are mounted about the rubber portions 307.

If desired, the pin 308 can be mounted in the roller in a position which is diametrically opposite the position shown, in such a manner that the pin moves outwardly and the obscuring of the light is reduced by the passage of a banknote through the nip 319.

Doubles detection may also be performed using an opacity detector and the detector system 300 may comprise such a detector.

Diverter System

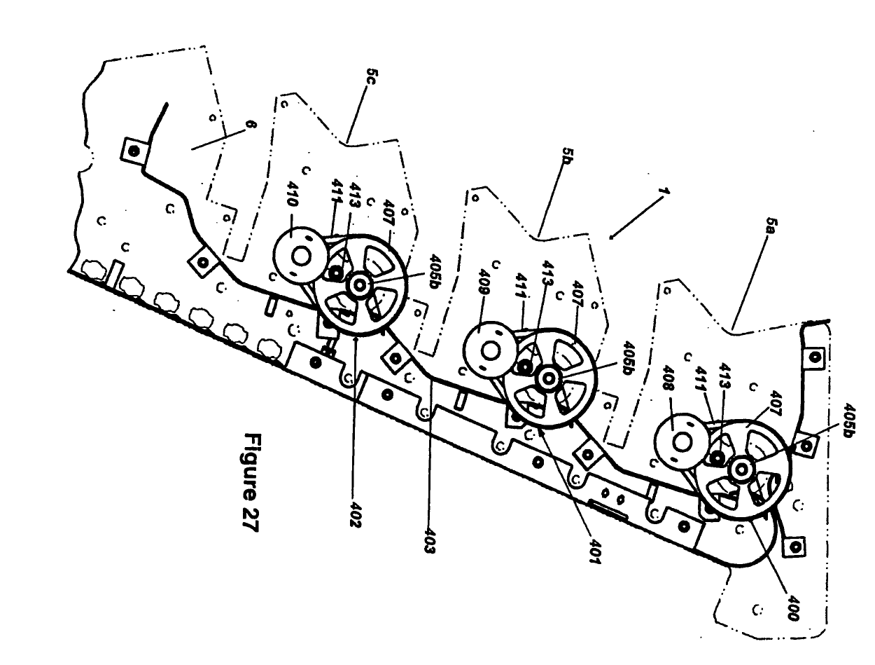

FIG. 27 shows the side view of part of the banknote sorting machine 1. The banknote sorting machine 1 comprises three diverter assemblies 400,401,402 each of which is disposed adjacent the transport path 403 and is operable to divert notes from the transport path 403 into respective pockets 5a, 5b, 5c. Any banknotes that are not diverted from the transport path 403 are deposited in a cull pocket 6.

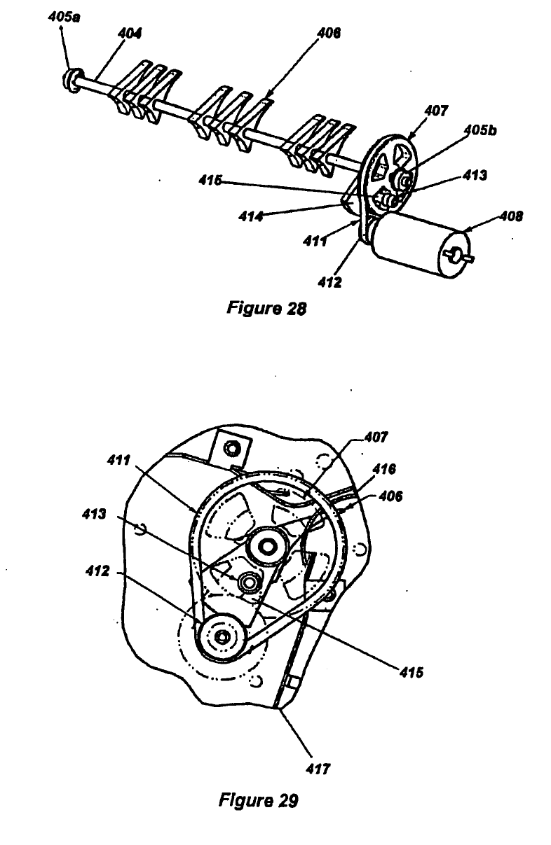

A more detailed view of one of the sheet diverter assemblies 400,401,402 is shown in FIG. 28 as a perspective view. The diverter assembly comprises a shaft 404 that is journalled in bearings 405a, 405b that are housed in opposite sides of the banknote sorting machine 1. A plurality of diverter vanes 406 are non-rotatably mounted on the shaft. The diverter vanes 406 are typically made from a lightweight but strong material, for example glass-reinforced plastic. Alternative materials include carbon-fibre-reinforced plastic or aluminium. These materials can be useful, as they are electrically conductive, for dissipating static charge from a bank note.

At one end of the shaft 404, there is mounted a diverter shaft pulley 407 which is coupled to a DC drive motor 408 via a resilient drive belt 411 and a drive motor pulley 412. The resilient drive belt 411 is typically a rubber O-ring stretched over the diverter shaft pulley 407 and the drive motor pulley 412. An end stop 413 is mounted on a fixed stop plate 414 such that the end stop 413 protrudes through a slot 415 in the diverter shaft pulley 407. In this way, the rotation of the shaft 404 is constrained to an arc defined by the size of slot 415. As such, the end stop 413 in conjunction with the slot 415 defines first and second positions of the diverter vanes 406.

Alternatively, the end stop 413 could be mounted on a sub-plate that can be moved relative to the rest of the assembly. As such, the position of the end stop 413 can be adjusted, for example to compensate for variability in the positioning of a note by the rest of the transport as it is directed at the sheet diverter assembly 400,401,402.

By rotating these diverter vanes 406 to the first of two positions the note can be diverted from the transport path 403 whilst in the second position the note continues on the transport path 403.

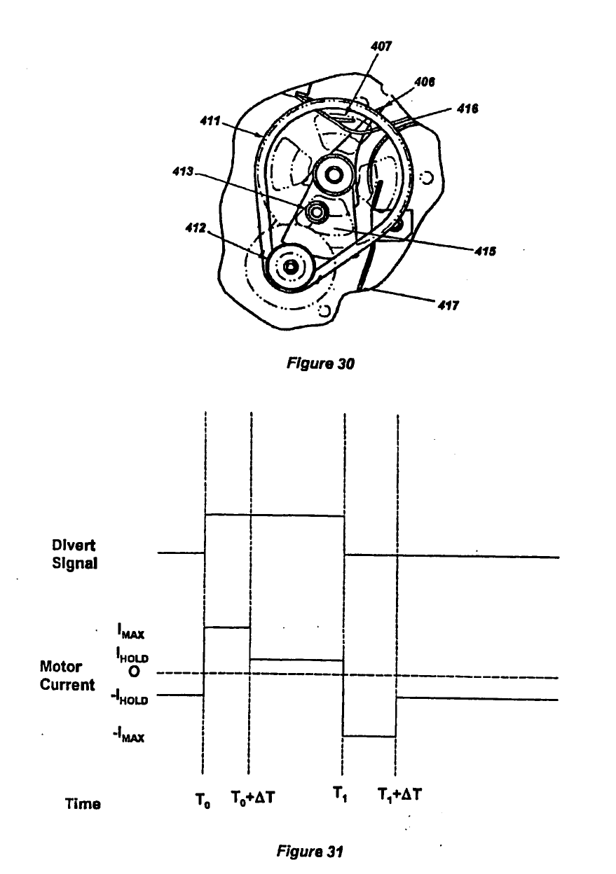

FIGS. 29 and 30 show side views of the diverter assembly in the first and second positions respectively. In FIG. 29, the diverter shaft pulley 407 and hence diverter shaft 404 and diverter vanes 406 have been rotated as far clockwise as possible such that the right hand end of slot 415 is pressing against end stop 413. The diverter vane 406 is positioned such that a sheet passing through aperture 416 (which forms part of transport path 403) is diverted along the top edge of diverter vane 406 into the respective one of the pockets 5a,5b,5c associated with the diverter.

Conversely, in FIG. 30 the diverter shaft pulley 407 has been rotated as far anti-clockwise as possible such that the left hand end of slot 415 is pressing against end stop 413. A sheet document, such as a banknote, passing through aperture 416 will then be diverted by the bottom edge of diverter vane 406 such that it continues along guide plate 417 which also forms a path of transport path 403. In this way, the note is not diverted from the transport path 403 and continues onto the next diverter assembly 5b,5c or to the cull pocket 6.

The operation of the diverter assembly will now be described with reference to FIG. 31. In this Figure, a timing diagram showing the relative timing of a divert signal and the motor current is shown. The diagram shows the signals for only one of the three diverters but the operation is identical for the other two.

In FIG. 31, a decision has been made to divert a particular note from the transport path 403 into a pocket 5a,5b,5c. As a result, the divert signal is asserted at T₀ and this causes a motor driver incorporated within the controller to drive the motor 408 at a current I_{MAX}. For example, I_{MAX} may be 1.5 amperes. After a time ΔT, the motor current is reduced to I_{HOLD} which for example may be 0.5 amperes. The time ΔT is chosen to guarantee that the diverter vanes 406 can move from one position to the other position before the current is reduced from I_{MAX} to I_{HOLD}. By driving the motor 408 in this way, the diverter vane is moved into position 1 as shown in FIG. 29 and the note is diverted into the respective pocket.

The actual time taken for the diverter vane 406 to move from one position to the other will typically depend on several factors, for example the friction in the bearings 405a and 405b and the inertia of the motor and diverter assembly. Thus, ΔT is chosen to be significantly larger than this actual time to guarantee that the diverter vanes has sufficient time to change position.

At time T₁, the controller makes a decision that another note is not to be diverted but is to continue on the transport path 403 and the divert signal is correspondingly negated. As a result of this the motor current polarity is reversed and set to a magnitude of −I_{MAX}. This causes the diverter to revert to position 2 as shown in FIG. 30. Again, at a time ΔT after T₁ the motor current is reduced to −I_{HOLD}, at which value it continues to flow. It is important to realise that the time ΔT could, in fact, be different for each direction of operation of the diverter.

This method of motor control allows the diverter vanes 406 to change position quickly but the motor current is then reduced to a level, I_{HOLD}, that holds the diverter shaft pulley 407 against the end stop 413 but which will not be sufficient to overheat and hence, damage the motor 408. This reduced current, I_{HOLD}, can be applied to the motor indefinitely.

A surprising advantage of reducing the motor current to a holding current in this way is that the reaction speed of the diverter is increased when the motor current polarity is changed because the magnetic field associated with the holding current, I_{HOLD}, is lower than that of the maximum current, I_{MAX}, and so there is a lower magnitude magnetic field to overcome. Thus, the diverter responds quickly when the diverter vane 406 is required to change position.

In a typical example, the value of I_{MAX} is 1.5 A and this is applied for 20 ms (i.e. ΔT=20 ms) before reducing the motor current to a value of I_{HOLD}=0.5 A. Furthermore, the act of continuing to drive the motor 408 prevents the drive belt 411 from relaxing and allowing the diverter vane 406 from being inadvertently moved. The motor 408 does not continue to rotate but instead is stalled and as such applies a constant torque to the drive motor pulley 412 thereby holding the diverter vane 406 firmly in place.

When the diverter vane 406 is required to change position, the resilient drive belt 411 is placed under tension since the motor 408 begins to move before the inertia of the diverter assembly 400,401,402, has been overcome. For example, if the motor 408 is rotated in an anti-clockwise direction to change from position 1, as shown in FIG. 29, to position 2, as shown in FIG. 30, then the drive belt 411 will be tensioned on its left hand side. As a result of this, the drive belt 411 stores energy during rotation of the diverter shaft 404 and diverter vane 406 and this energy is input into the system after the left hand end of slot 415 strikes end stop 413 and mitigates the rebound of diverter vane 406 from the end stop 413. In essence, the energy stored in the drive belt 411 attempts to pull the diverter shaft pulley 407 past the end stop 413 and this prevents the diverter shaft pulley 407 from rebounding from the end stop 413.

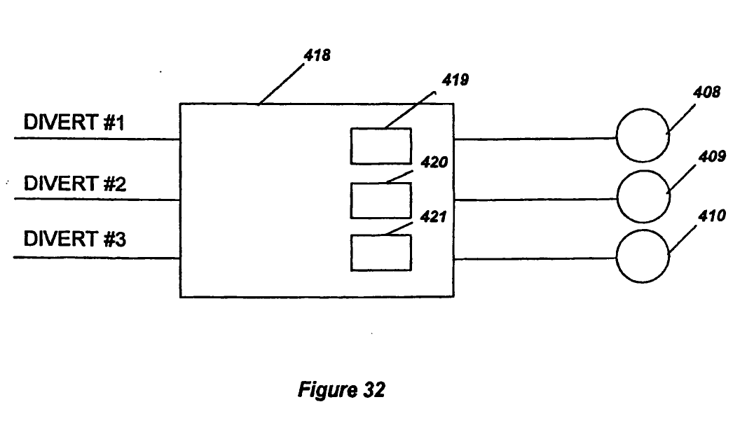

FIG. 32 shows a schematic view of a controller 418, in this case located on the motor controller PCB, for driving the motor 408 along with motors 409,410 for driving the other two diverter assemblies 401,402 in the banknote sorting machine 1.

On assertion of signal DIVERT #1, the controller 418 causes output driver 419 to drive motor 408 at current I_{MAX} for ΔT such that the diverter vanes 406 are moved so as to divert banknotes from transport path 403. After ΔT, controller 418 causes output driver 419 to reduce the motor 408 current to I_{HOLD}. This holding current is maintained, as previously described, until DIVERT #1 is negated when controller 418 causes output driver 419 to drive motor 408 at current −I_{MAX} for ΔT thereby returning the diverter vane 406 to the default position such that it does not divert banknotes from the transport path 403. After ΔT, the current is reduced to −I_{HOLD} at which value it remains until DIVERT #1 is again asserted.

Controller 418 controls motors 409 and 410 via output drivers 420 and 421 in the same way in response to signals DIVERT #2 and DIVERT #3.

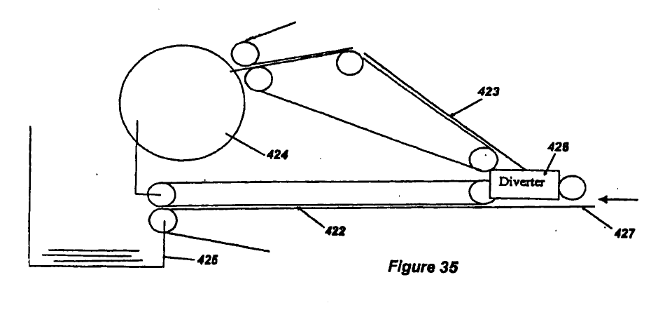

FIG. 35 shows schematically a possible way for improving the banknote sorter 1 such that notes presented in a mixture of face-up and face-down configurations may be stacked in a single pocket, but all in the same configuration, that is, either face-up or face-down. In FIG. 35, banknotes that are to be stacked in an output pocket 45 are fed along a transport path 427. If the note is in a correct Facing then the diverter 426 is not actuated and the note proceeds along a first transport path 422. The note is then stacked in output pocket 425 without changing the way in which it is facing.

However, if the note is not in the desired configuration, for example it is face-down when it is required that it should be face-up, then the diverter 426 is activated and the note is diverted along a second transport path 423. This transport path 423 conveys the note to a tine wheel 424 which inherently reverses the face configuration of the note and deposits it in the output pocket in the opposite configuration to that which it had originally. Hence, all notes conveyed along the transport path 427 are stacked in the output pocket 425 in the same face configuration.

In another embodiment, the diverter motors 408 to 410 may be replaced by linear or rotary solenoids.

Output Pockets

Each output pocket 5a,5b and 5c is formed from a metal casing 500 that is folded to enclose the components of the output pocket and also to form a receptacle 501 in which banknotes diverted to the respective pocket can be stacked.

Within the casing 500 of the pocket 5a,5b or 5c there are three shafts on which each of the pairs of pinch rollers 213 are mounted, and a fourth shaft on which a pair of tine wheels 512 are mounted. The shaft on which the tine wheels 512 are mounted is rotatably coupled with one of the shafts 502 on which one pair of pinch rollers 213 are mounted such that the tine wheels move in sympathy with the transport belts 212.

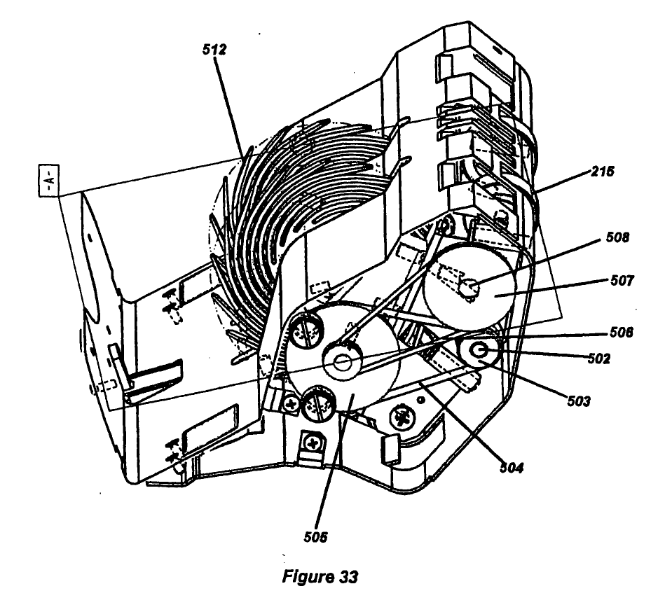

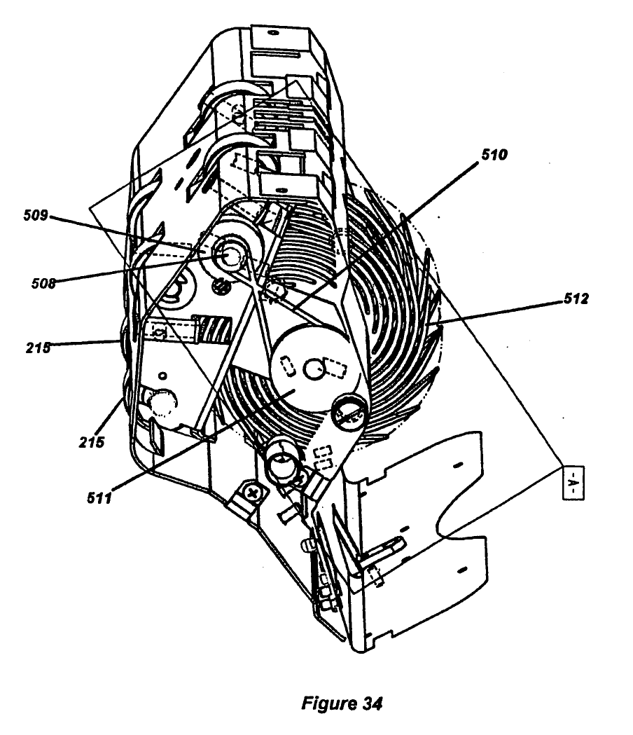

This is best shown in FIGS. 33 and 34. In FIG. 33 there can be seen a shaft 502 which is one of the shafts in which one of the pair of pinch rollers 213 are mounted. A pulley 503 mounted on shaft 502 is coupled via drive belt 504 with a pulley 505 which is coupled via another drive belt 506 to pulley 507. Pulley 507 is mounted on shaft 508 which passes across the width of the pocket as can be seen in FIG. 34. At the other end of shaft 508 is mounted a pulley 509 which is coupled to tine wheel pulley 511 via drive belt 510. The drive belt 510 is crossed over as can be seen in FIG. 34 such that the direction of rotation of the tine wheel 512 is clockwise in FIG. 34. The tine wheel pulley 511 is mounted on the same shaft as the tine wheel 512.

Notes diverted from the transport path are driven into the tines of the tine wheels 512 and then laid flat in the receptacle 501.

The presence of a note in the receptacle 501 is detected by means of a note sensor emitter 513 and corresponding note sensor detector 514, as shown for example in FIG. 12. The note sensor emitter 513 emits a beam of radiation that is detected by the note sensor detector 514 through an aperture 515 in the casing 500. When a note is deposited in the receptacle 501, this beam of radiation is interrupted so the presence of the note can be detected.

In another variant of the output pocket, it is provided with its own drive motor (not shown). This has some advantage in that it can surprisingly reduce the cost of the output pocket. In this case, the tine wheel 512 may be stopped independently of the transport, and this allows a note matching a certain set of characteristics to be retained in the tine wheel when it has been brought to rest.

For example, a note indicated by the detector system 300 to be counterfeit, may be diverted into an output pocket, and the drive motor for the output pocket brought to rest such that the note is retained in the tine wheel 512 in a vertical presentation to the user.

The tine wheel 512 may be brought to rest by removing the drive excitation to the output pocket drive motor a predefined length of time after the document has been sensed by one of the transport sensors, for example the pre-divert sensor 223. It is possible for the document transport to remain running in this case, since it is independently driven.

Cull Pocket

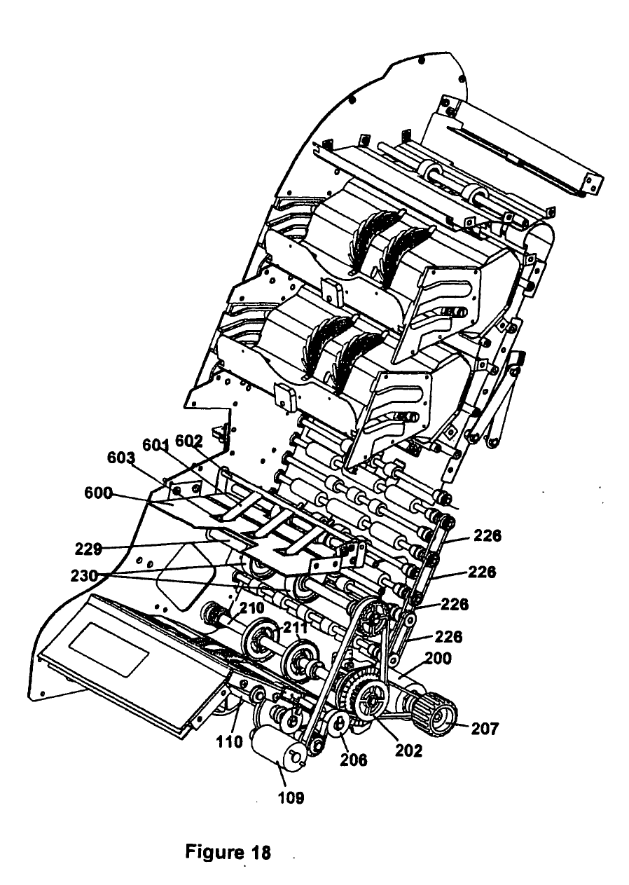

Any banknotes that are not diverted from the transport are deposited in a cull pocket 6. This is best seen in FIG. 18.

It can be seen that the cull pocket is simply a metal receptacle 600 on which the undiverted banknotes are stacked. A set of fingers 601 are mounted on a shaft 602. When no banknotes are present in the receptacle 600, the fingers project through apertures 603 in the receptacle 600. However, when a banknote is stacked in the cull pocket, this causes the fingers to be lifted thereby rotating the shaft 602 which is operable to actuate a sensor (not shown). The projection of the fingers 601 through the apertures 603 assists in detection of the first note to enter the cull pocket 6 since the fingers 601 then are lifted by a large amount through the apertures 603. If the fingers 601 simply rested on the base of the cull pocket 6 the movement caused when the first note entered the cull pocket 6 may be too small to discriminate.

The sensor may be a microswitch actuated by rotation of shaft 602. However, actuation of a microswitch may require a significant ammount of energy. Another possibility which overcomes this problem includes mounting a flag on the end of shaft 602 that interrupts a light beam between an emitter and detector when the shaft 602 rotates. Alternatively, the flag may be moved by rotation of shaft 602 such that it no longer blocks the beam of light when a note is present in the cull pocket 6. Yet another possibility includes mounting a magnet on the end of shaft 602, rotation of which causes the magnet to move into close proximity of (or indeed, away from) a Hall effect device that senses the presence (or absence) of the magnet.

Thus, the presence of a note in the receptacle 600 can be detected. The fingers 601 also act to prevent a note from flying out of the cull pocket 6.

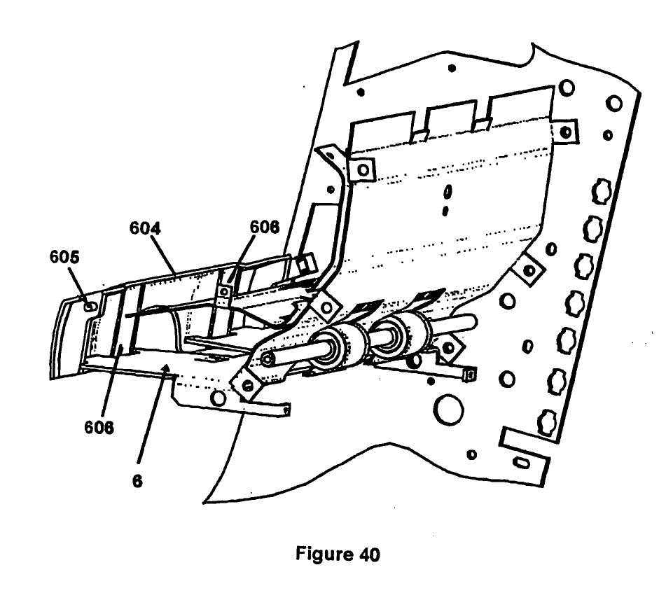

The cull pocket 6 may be provided with a cover 604, as shown in FIG. 40. The cover 604 is hingeable about hinge points 605 so that notes may be removed from the cull pocket 6. However, in the position shown banknotes diverted to the cull pocket 6 come to rest against stops 606 (which are integral with the cover 604) and are thereby prevented from flying out of the cull pocket 6.

Electronic Control System

The operation of the banknote sorter 1 is coordinated and controlled by electronic circuitry distributed across four printed circuit boards. These are the main controller PCB, the mode controller PCB, the transport controller PCB and the detector PCB.

Main Controller PCB

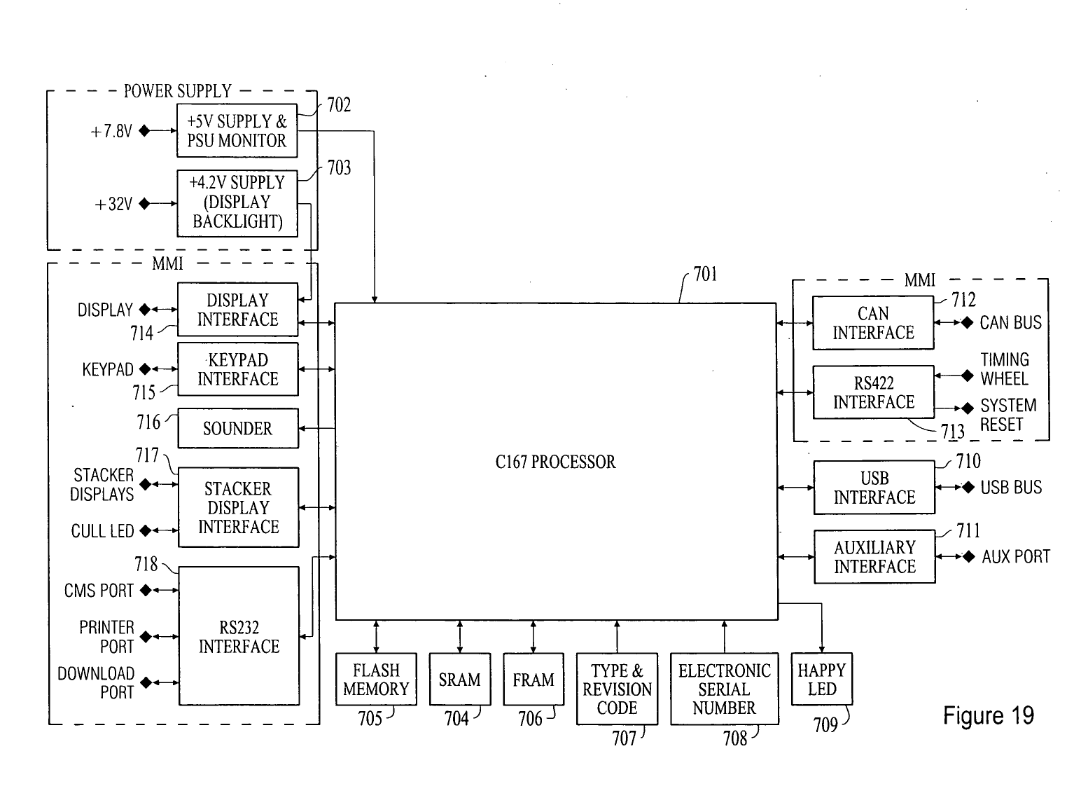

The main controller PCB is shown in the form of a schematic block diagram in FIG. 19. It is based around an Infineon C167 microprocessor 701. The main controller PCB is provided with power at 7.8 volts and 32 volts. The 7.8 volt supply is regulated by a 5 volt regulator and PSU monitor 702 to supply 5 volts to the circuitry of the main controller PCB. The 32 volt supply is regulated to 4.2 volts for the purposes of supplying the back light in the display 11. The 5 volt regulator and PSU monitor 702 is adapted to issue a reset signal to the circuitry of the main controller PCB when the 7.8 volt supply falls below a threshold level at which the regulator can no longer supply its 5 volt output, for example when the banknote sorter 1 is switched off.

The microprocessor 701 is also connected to static random access memory (SRAM) 704 and to non-volatile memory in the form of a flash memory 705 and a ferromagnetic random access memory (FRAM) 706. Suitable devices for the FRAM 706 are manufactured by Ramtron and this type of device is used since it is non-volatile and extremely fast and although it is electronically programmable, it may be re-programmed more than 10 billion times.

An 8-bit latch 707 is provided that latches, on power-up, a code formed by hard-wired links connected to its inputs. The first 6-bits of the code indicate the type or version of the PCB and the other 2-bits indicate the PCB=s revision or issue.

A second serial access, 64-bit ROM 708 stores a serial number for the main controller PCB to enable it to be uniquely identified. Such identification may be useful for the purposes of servicing, and for downloading software updates via the Internet. A suitable device is the Dallas Semiconductor DS2401.

A light emitting diode (LED) 709 is provided to indicate that the main controller PCB is functioning correctly.

The main controller PCB is also provided with a universal serial bus (USB) interface 710 and an auxiliary interface 711, both of which are connected to the C167 microprocessor 701.

The C167 microprocessor 701 is provided with a controller area network (CAN) interface and this is used for communication between the main controller PCB and the transport controller PCB. The main controller PCB acts as the CAN master.

An RS422 interface 713 is also used to provide communication between the main controller PCB and the transport controller PCB. This interface conveys timing wheel information from the transport controller PCB to the main controller PCB and can be used by the main controller PCB to issue a system reset. The transport controller PCB on receipt of a reset signal from the main controller PCB resets the motor controller PCB.

The C167 microprocessor 701 is further connected to a display interface 714 and keypad interface 715 which are respectively connected to the display 11 and keypad 10. The display interface 714 can address any of the pixels in the 192×64 pixel liquid crystal display (LCD) 11. The display interface 714 also conveys power from the 4.2 Volt regulator 703 to the display 11 for the purposes of illuminating the back light. The keypad interface 715 receives signals from the keypad 10 produced in response to one or more keys being depressed.

A sounder 716 is provided that can emit a sound when a key on the keypad 10 is depressed or when an error occurs.

The stacker displays 8a to 8c and the cull pocket indicator 9 are controlled by the stacker display interface 717. This causes each counter display 8a to 8c to indicate the quantity, value or currency of banknotes present in the respective output pocket 5a to 5c and illuminates the cull pocket indicator when a banknote is present in the cull pocket 6. The interface 717 may also cause the display 8a to 8c to flash if the associated pocket 5a to 5c requires attention, for example because it is full.

An RS232 interface 718 is provided that can transmit and receive signals via a printer port, a download port and a Cash Management System (CMS) port. The download port is used to download new software to the main controller PCB for the purposes of field updates.

The CMS port allows the banknote sorter 1 to be connected to a remote personal computer which can then monitor the throughput of the sorter 1, or exercise full remote control of the sorter 1.

Motor Controller PCB

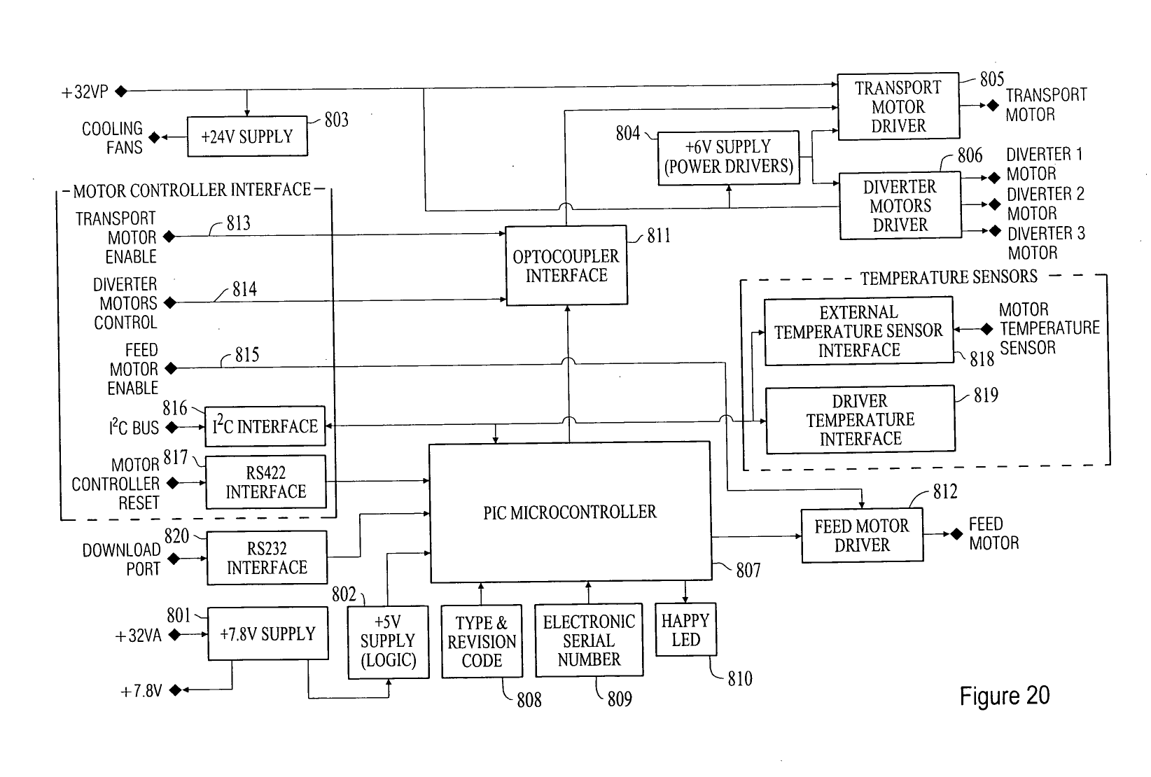

The motor controller PCB schematic block diagram is shown in FIG. 20.

The PCB receives two separate 32 volt supplies from the power supply unit 19. The first 32 volt supply is connected to a 7.8 volt regulator 801 that produces a 7.8 volt supply that is supplied to the transport controller PCB and main controller PCB. The output from the 7.8 volt regulator 801 is also provided to a 5 volt regulator 802 that generates a 5 volt power supply for the logic circuitry on the motor controller PCB.

The second 32 volt supply is connected to a 24 volt regulator 803 that is used to provide the power necessary to drive the cooling fans. It is also connected to the transport motor driver 805 and diverter motors driver 806 and to a 5 volt regulator 804 that generates a 5 volt supply used by the transport motor driver 805 and the diverter motors driver 806.

The motor controller PCB is based around a PIC microcontroller 807.

In the same manner as the main controller PCB, the motor controller PCB is provided with a latch 808 and a serial ROM 809, connected to the PIC microcontroller 807, that indicate-type and revision code data and store an electronic serial number respectively.

There is also provided an LED 810 that is illuminated to indicate that the motor controller PCB is operating correctly.

The PIC microcontroller 807 is connected to a feed motor driver 812 and to the transport motor driver 805 and diverter motors driver 806 via an optocoupler interface 811. The optocoupler interface 811 isolates the PIC microcontroller 807 from the transport motor driver 805 and diverter motors driver 806 such that electrical noise generated by these does not interfere with the operation of the PIC microcontroller 807.

The PIC microcontroller 807 is operable to cause the transport motor driver 805, diverter motors driver 806 and feed motor driver 812 to supply power at 32 volts to the transport motor, diverter motors and feed motor respectively in the desired polarity. Speed control of each of these motors is achieved using pulse width modulation.

Each of the transport motor driver 805, diverter motors driver 806 and feed motor driver 812 requires a corresponding enable signal to be asserted in order to be activated. These signals are the transport motor enable signal 813, the diverter motors enable signal 814 and the feed motor enable signal 815. These are supplied by the transport controller PCB as will be described later.

The motor controller PCB may also communicate to the transport controller PCB via an I²C interface 816, and via an RS422 interface 817 through which the motor controller PCB receives a reset signal issued by the transport controller PCB.

The motor controller PCB is also provided with an external temperature sensor interface that is connected to a transport motor temperature sensor (not shown) on the transport motor 200 casing in order that the PIC microcontroller 807 can monitor the temperature of the transport motor 200 and shut down the transport if this exceeds a threshold.

A driver temperature interface 819 monitors the temperature of the transport motor driver 805 and diverter motors driver 806 via sensors on the motor controller PCB provided adjacent to drivers 805 and 806. If any of these temperatures exceeds a predetermined threshold the transport motor driver 805 and diverter motors driver 806 are shut down. Providing these temperature sensors allows the drivers 805 and 806 to be used closer to their operational temperature limits. In addition, it is possible to reduce the speed of operation of a motor as the temperature approaches the predetermined threshold to attempt to obviate the need to shut down the driver.

In order to dissipate the heat produced by the transport motor driver 805, diverter motors driver 806 and feed motor driver 812, the motor controller PCB is provided with a heat sink that is thermally coupled to thermal vias in the PCB that are connected to the transport motor driver 805, diverter motors drivers 806 and feed motor driver 812.

An RS232 interface 820 is provided to connect the PIC microcontroller 807 to a download port through which software updates can be downloaded to the motor controller PCB.

Transport Controller PCB

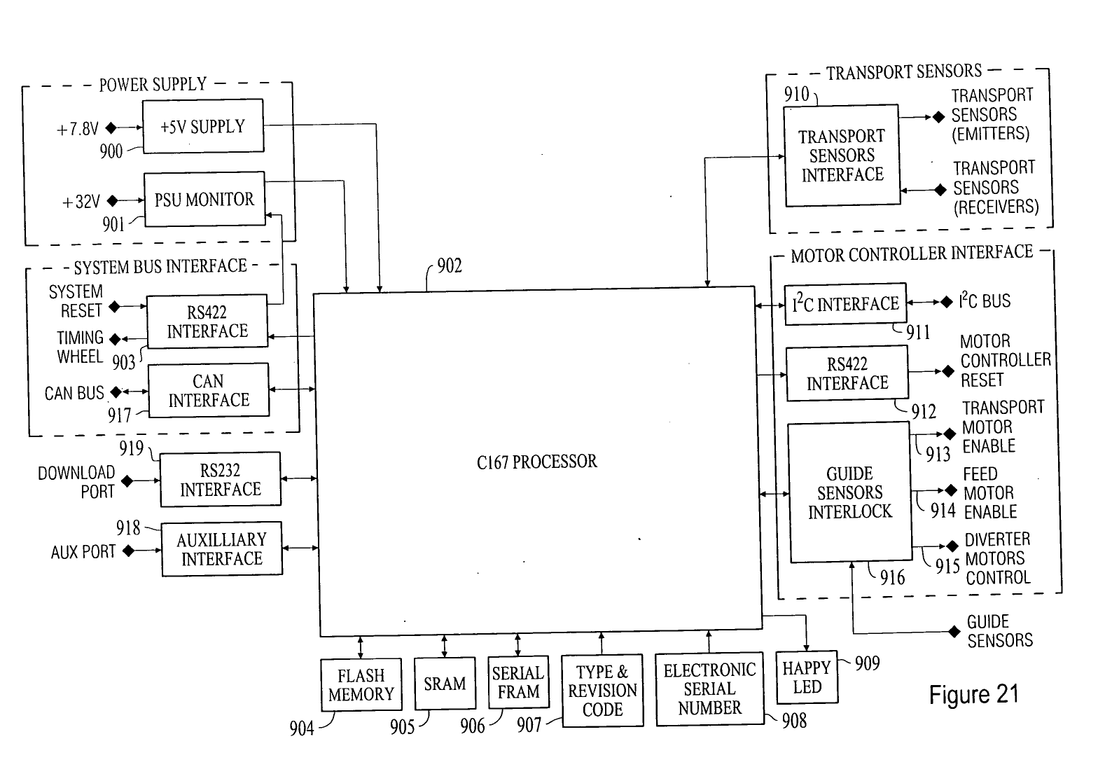

The transport controller PCB is shown in FIG. 21.

The transport controller PCB receives power at 7.8 volts from the motor controller PCB and regulates this to 5 volts using a 5 volt regulator 900. The resultant 5 volt output is used to power the circuitry on the transport controller PCB.

A power supply monitor 901 monitors the output from the 5 volt regulator 900 and also the 32 volt power supply from the power supply unit 19 and if either of these falls below a respective predetermined threshold then a reset signal is issued to the C167 microprocessor 902. The power supply monitor 901 also receives a system reset signal via an RS422 interface 903 which enables the main controller PCB to reset the transport controller PCB and motor controller PCB as already described. The RS422 interface 903 also receives signals from the transport timing detector 209. This interface is used to improve the noise immunity of the signals which might otherwise be prone to indicating false detection of one of the array of slots 208, resulting in errors of measuring the transport speed and displacement.

The transport controller PCB has the same arrangement of volatile and non-volatile memory as the main controller PCB. That is to say that it is provided with a flash memory 904, a static RAM 905 and a serial FRAM 906. Similarly, the C167 microprocessor 902 is connected to an 8-bit latch 907 that indicates type and revision code data, and a serial ROM 908 that contains an electronic serial number for the purpose of uniquely identifying the transport controller PCB.

An LED 909 is provided that is illuminated to indicate that the transport controller PCB is operating correctly.

A transport sensors interface 910 is connected to the post-detect and pre-divert sensors so that the position of the banknotes in the transport can be monitored by the C167 microprocessor 902.

The transport controller PCB communicates with the motor controller PCB via an I²C interface 911 and via an RS422 interface 912 through which the transport controller PCB can issue a reset command to the motor controller PCB.

The communication between the transport and motor controller PCBs allows motor control signals to be generated on the transport PCB which only has logic level circuitry. These signals are conveyed to the motor controller PCB and are converted to high power signals to drive the motors. This prevents noise that may be generated by the high power signals from interfering with the motor control signals, thereby improving the noise immunity.

The C167 processor 902 is also operable to assert a transport motor enable signal 913, a feed motor enable signal 914 and a diverter motors enable signal 915 which are connected to the motor controller PCB as already described. A guide sensors interlock 916 is provided such that these three signals are negated when one of a plurality of guide sensors (not shown) detects that the respective output pocket 5a, 5b or 5c has been pulled into its jam clearance position or the casing 2 or rear access cover 22 have been opened. The guide sensors are typically microswitches.

In addition to receiving system reset commands from the main controller PCB the RS422 interface 903 is used to transmit timing wheel data from the C167 processor 902 on the transport controller PCB to the main controller PCB.

In addition, there is provided a CAN interface 917. The CAN interface allows data to be shared between the devices connected to it, including the main controller PCB, the transport controller PCB and the detector PCB.

The C167 processor 902 is also connected to an auxiliary interface which is connected to an auxiliary port (not shown) and to a RS232 interface 919 that can receive updated software that is downloaded to the transport controller PCB.

Detector PCB

The detector PCB is not shown in any of the drawings but will be briefly described here.

It is based around a digital signal processor (DSP) and a reconfigurable field programmable gate array (FPGA), normally a Xilinx7 Spartan7. The memory system includes flash memory and a static RAM. The PCB is also provided with a USB port for initial calibration and an RS232 interface for diagnostic purposes.

The detector system PCB receives signals from a variety of detectors which may include magnetic, ultra-violet, infra-red, visible and foreign object detectors. The signals are processed by the digital signal processor and FPGA to determine the characteristics of each note that passes through the detector system 300.

Machine Operation

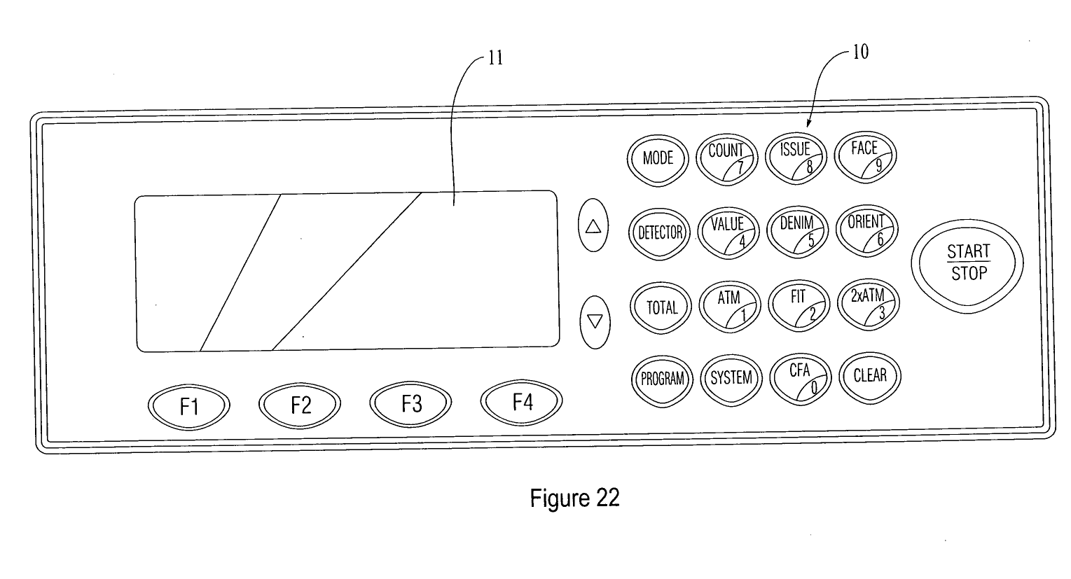

The banknote sorter 1 is operated by means of the keypad 10 and information is provided to the user via the display 11. These are shown in detail in FIG. 22.

The display 11 is a 192×64 pixel liquid crystal display (LCD). Each of the pixels is individually addressable and the display may therefore be used to display graphics and text.

The keypad 10 comprises 16 mode keys, a start/stop key, two scroll arrows for scrolling up and down the display 11, and 4 soft keys that perform actions associated with icons that may be displayed on the display 11 adjacent to the relevant soft key.

When the banknote sorter is switched on, a message is displayed on display 11 requesting the user to input a user password. When the password is correctly entered, the banknote sorter defaults to an idle mode.

When in idle mode, the banknote sorter 1 will begin to sort banknotes that are placed on the feeder hopper automatically if the banknote sorter 1 is configured to start automatically. Alternatively, the start key must be pressed if the banknote sorter 1 is in a manual mode of operation. In this running mode, the banknote sorter 1 can be returned to the idle mode by pressing the start key.

When in idle mode, the operator of the banknote sorter 1 may also select the sorting function mode that the banknote sorter 1 operates in. The sorting functions are split into three categories. The first category is the hot function mode. There are nine hot functions and these are selected by pressing one of the keys labelled ATM, FIT, 2×ATM, VALUE, DENOM, ORINT, COUNT, ISSUE or FACE. Pressing one of these keys causes the banknote sorter 1 to enter a predefined sorting mode as will be described later.

The second category is the combination function mode in which the operator can configure the sorting operation of the banknote sorter 1 according to his current needs.

The third category is the user defined mode in which one of nine user-defined, pre-stored combinations of sorting mode can be used by pressing the program key followed by one of the number keys.

When in idle mode, the banknote sorter can be caused to enter the configuration mode by depressing the SYSTEM key. In this mode, the operator can change the configuration operations of the banknote sorter. These include selection of automatic or manual feeding, setting the sorting speed, setting the maximum batch quantity that each output pocket and the cull pocket may contain, selecting the currency for sorting, specifying the user password and specifying a system password which is used to prevent unauthorised users from changing this configuration data. Furthermore, the current configuration parameters may be saved as a user-defined mode. A default configuration may also be loaded to replace the current configuration.

The final operating mode is the information mode which is entered from the idle mode by pressing the TOTAL key. In this mode, information such as the total number of notes sorted or their value may be displayed on the display 11 or transmitted to a PC.

Cull Pocket Configuration

The cull pocket 6 receives notes that are unrecognised or are not suitable for sorting. It may also be configured to receive certain types of notes based on characteristics of the notes that are detected by the detector system 300.

For example, notes may be tested for their authenticity using ultraviolet, infrared, magnetic pattern, magnetic thread code or size detectors and any notes deemed to be non-authentic may be sent to the cull pocket 6. Other possible examples include fitness detection based on a degree of soil, holes, tears, folds and damage to the magnetic thread. The notes may also be sent to the cull pocket 6 due to irregular presentation such as skew feeding, double feeding or stream-feeding of notes.

The display 11 may be used to indicate which detectors are in use by displaying an icon, and the sensitivity of certain types of detectors may be adjusted by the user.

The CFA key on the keypad 10 is provided to allow a user to switch off the authenticity detectors. The fitness and presentation detectors remain enabled.

Instead of passing a note that the detector system 300 indicates is not authentic to the cull pocket 6, it may be diverted to one of the output pockets 5a,5b,5c. The relevant pair of tine wheels 512 may then be stopped with the note still in the tines, for example in a vertical configuration. This clearly identifies the suspect note to a user. When the note is held in this position, the user may remove the note for further inspection, replace it with a note that is known to be authentic, or override the decision to reject the note. In the latter case, the user may, for example, enter the note=s denomination when the banknote sorter 1 failed to determine this.

Output Pockets

The lower two output pockets 5b and 5c are known as the sort pockets and distribution of notes into these is controlled by signals from the detector system 300.

The detector system 300 is used to characterise each note that passes through it. The note is characterised for note identity (such as currency, denomination and issue) orientation and note facing, and fitness.

The characteristics of the note are used to sort it into one of the sort pockets provided it meets all criteria that are set for that pocket. Notes that do not match the criteria of either of the sort pockets are sent to output pocket 5a. However, in some cases, the user may configure pocket 5a to receive certain types of note in which case notes that are not sorted to any of the pockets 5a to 5c are sent to the cull pocket 6.

The table below shows each of the note characteristics and pocket settings which may be applied to any of the output pockets 5a to 5c.

| | Pocket | |
|---|---|---|
| Characteristic | Setting | Meaning |
| Denomination | Off | Denomination sorting is not |
| | | used. Any denomination may be |
| | | sent to the pocket |
| | Auto-1 | The first denomination fed |
| | Auto-2 | The second denomination fed |
| | Fixed | The required denomination is |
| | | specified by the user |
| Issue | Off | Note issue sorting is not used. |
| | | Any issue may be sent to the |
| | | pocket |
| | Auto-1 | The first issue fed |
| | Auto-2 | The second issue fed |
| | Fixed | The required issue is specified |
| | | by the user |
| Orientation | Off | Orientation sorting is not used. |
| | | Any orientation may be sent to |
| | | the pocket |
| | Auto-1 | The first orientation fed |
| | Auto-2 | The second orientation fed |
| | Fixed | The required orientation is |
| | | specified by the user |
| Face | Off | Face sorting is not used. Any |
| | | face may be sent to the pocket |
| | Auto-1 | The first face fed |
| | Auto-2 | The second face fed |
| | Fixed | The required face is specified |
| | | by the user |
| Fitness | Off | Fitness sorting is not used. Any |
| | | fitness may be sent to the |
| | | pocket |
| | ATM | A preset ATM fitness level |
| | TELLER | A preset teller fitness level |
| | Fixed | The required fitness level is |
| | | specified by the user |
| Country of | Off | Country of issue sorting is not |
| Issue | | used. Any country of issue may |
| | | be sent to the pocket |
| | Auto-1 | The first country of issue fed |
| | Auto-2 | The second country of issue fed |
| | Fixed | The required orientation is |
| | | specified by the user |

The Auto-1 setting is used to configure the pockets to receive the first note type fed. For example, in the case of denomination, setting up pocket 5b to Auto-1 will cause it to receive all notes that are the same denomination as the first note that is fed into the banknote sorter 1. The first subsequent note fed that has a different denomination will be sent to output pocket 5c and the denomination of this note will become the denomination for subsequent notes that are fed to pocket 5c. All notes of other denominations will be sent to output pocket 5a.

Another possible sorting mode is based on the denomination of notes being sorted. In this mode, notes of: one selected denomination are sorted into a first one of the pockets 5a, 5b and 5c. Every other note (except those that are sent to the cull pocket 6) are sorted to a second one of the pockets 5a, 5b and 5c. The value of the notes of the selected denomination sorted to the first pocket and of the notes sorted to the second pocket can be maintained and displayed on display 11 or on counter displays 8a to 8c.

Other note characteristics, for example currency, may be used to sort notes into respective output pockets 5a to 5c.

In another operating mode, two pockets may be assigned to receive sorted notes in alternation such that, for example, 10 notes are initially sorted into pocket 5b until this becomes full when notes will be instead sorted to pocket 5a. This enables pocket 5b to be emptied whilst pocket 5a fills, and when it becomes full notes can be sorted into pocket 5a again. This allows continuous operation of the machine.

An extension of this mode is best described by example. In this example, 10 notes are sorted to pocket 5b and, 20 notes to pocket 5c. Pocket 5a is then used as in the above described example, but in this case it receives notes from which ever of pockets 5b and 5c fills first.

The sorter may also be operated in a single-shot mode such that when a pocket approaches capacity, the notes are fed from the hopper 100 one at a time. This is advantageous since it is possible that the transport could have several notes in it that would be sorted ideally to a specific pocket. However, if one of these notes causes the pocket to become full then the remaining notes can only be rejected to the cull pocket 6. Single-shot mode prevents this because only one note is in the transport at any one time and if this causes a pocket to become full, no further notes are fed from the hopper 100.

Fitness Measure

The detector system 300 produces a fitness signal that reports the overall condition of a note that is fed through it. The signal has a value between 0 and 15 with 0 being the poorest condition and 15 the best condition.

The algorithm used to generate the fitness signal combines individual results from several fitness detectors (for example a soil detector, hole detector, tear detector and fold detector). Each of these parameters may have a weighting factor applied to it to determine the effect it has on the overall fitness signal. The weighting factors vary in the range from 0 to 255.

The advantage of combining weighted measurements is that, for example, a slightly dirty note with a small fold may be rejected as would notes that were very dirty or had large folds, and all of these may be equally unacceptable.

In order for each parameter to contribute equally, all factors should be set to 127. Increasing the weighting factor above 127 will increase the effect that the parameter has on the fitness signal whilst decreasing the value reduces the effect. Setting a weighting factor to 0 prevents the parameter from having any effect on the fitness signal.

The user may adjust the weighting factors for each fitness detector to control the balance of fitness sorting criteria.

The user may assign a specific fitness sort level to an output pocket 5a to 5c or alternatively one of two preset levels may be used.

The first preset level is known as ATM, and is used to sort notes that are suitable for use in cash dispensers. The second fitness level is known as FIT and is used to sort notes that are suitable for reissuing by a bank teller.

Fitness detection may be used in two ways. It may be used to send unfit notes to the cull pocket 6 or it may be used to sort notes to the output pockets 5a to 5c depending on their level of fitness.

As already described, the signals received from each detector are multiplied by a weighting factor. The detectors may detect the degree of soiling of a note, the size of a tear in a note, the size of a fold in a note, the area of a hole in a note, the amount of damage to a thread embedded in a note, and the size of a note. The weighted signals are then added together to produce a sum. A note may be rejected to the cull pocket 6 if the sum exceeds a predetermined threshold. Alternatively, the notes may be sorted into the output pockets 5a to 5c depending on the value of the sum.

An alternative mode of operation that uses weighting factors is now described with reference to the following table:

| Weighting | Fitness | Soil | Tear | Fold | Hole | Thread | Size |
|---|---|---|---|---|---|---|---|
| factor | level | (%) | (mm) | (mm) | (mm²) | (%) | (mm) |
| OFF | 10 | 0 | 10 | 30 | 100 | 5 | 10 |
| −4 | 9 | 10 | 9 | 27 | 81 | 15 | 9 |
| −3 | 8 | 20 | 8 | 24 | 64 | 25 | 8 |
| −2 | 7 | 30 | 7 | 21 | 49 | 35 | 7 |
| −1 | 6 | 40 | 6 | 18 | 36 | 45 | 6 |
| 0 | 5 | 50 | 5 | 15 | 25 | 55 | 5 |
| 1 | 4 | 60 | 4 | 12 | 16 | 65 | 4 |
| 2 | 3 | 70 | 3 | 9 | 9 | 75 | 3 |
| 3 | 2 | 80 | 2 | 6 | 4 | 85 | 2 |
| 4 | 1 | 90 | 1 | 3 | 1 | 95 | 1 |
| 5 | 0 | 100 | 0 | 0 | 0 | 100 | 0 |

In this alternative, each fitness detector may be used in two different ways. They may be used as cull detectors whereby unfit notes are sent to the cull pocket 6, or they may be used in a fitness sort mode to direct notes to different output pockets 5a to 5c depending on their fitness level.

For example, the default weighting factor is 0 such that any note for which the size of a fold exceeds 15 mm will be sent to the cull pocket 6. Similarly, any note with a tear greater than 5 mm will also be sent to the cull pocket 6. However, if a weighting factor of −2 is applied to the fold detector and a weighting factor −3 is applied to the tear detector, then any note with a fold exceeding 21 mm and any note with a tear exceeding 8 mm will be rejected to the cull pocket 6.

This mode may also be used for fitness sorting to the output pockets 5a to 5c. For example, by default ATM condition equates to a fitness level of at least 5 and FIT condition to at least fitness level 8. Taking the fold detector as an example, this means that a note can have folds totalling no more than 15 mm for use in an automated teller machine (ATM) and no more than 24 mm for use by a teller. Accordingly, notes meeting fitness levels 1 to 5 may be sorted to output pocket 5a and notes meeting fitness levels 5, 6, 7 or 8 may be sorted to output pocket 5b. Thus, the user knows that notes in pocket 5a are usable by an ATM whilst notes in pocket 5b are usable by a teller. However, if the weighting factor of −2 is applied then notes with folds of 21 mm will be considered to meet the ATM fitness level and notes with folds of 30 mm will be considered to meet the FIT fitness level.

Batch and Stop Conditions

Each output pocket 5a to 5c has a maximum batch capacity of 100 notes by default. This limit may be adjusted individually for each output pocket 5a to 5c up to a maximum of 200 notes.

The cull pocket 6 has a maximum capacity of 50 notes, but by default the capacity is set to 20 notes.

Maximum batch numbers may also be specified by setting a maximum value of notes that may be present in a pocket. In this way, the batch size will be adjusted automatically depending on the denomination of the note. Thus, for example, a pocket may stop when it has received 100, 10 notes or 50, 20 notes as these both amount to, 1000. Furthermore, the sorter may be configured so that a pocket receives the first note fed from a stack placed in the hopper, and then all subsequent notes with the same denomination in the stack are fed to the same pocket until it has the maximum value within it. Further notes of the same denomination may be diverted then to another pocket whilst the first is emptied. Alternatively, one of the other pockets may receive the first and all subsequent notes from the stack that have a different denomination to the first note fed. Normally, all notes that are detected as counterfeit will be rejected to the cull pocket 6.

The banknote sorter 1 may be configured to operate in any one of three stop modes which are shown in the table below.

| Stop Mode | Description |
|---|---|
| Single | The sort operation stops whenever any |
| | pocket becomes full. |
| Cyclic A | The sort operation stops when both sort |
| | pocket are full. If the user empties the |
| | Pockets as they become full then the |
| | sorter will cycle between using pocket 5c |
| | and pocket 5b. |
| | The sorter will also stop whenever pocket |
| | 5a or the cull pocket 6 are full. |
| Cyclic B | The sort operation stops when all pockets |
| | 5a, 5b and 5c are full. If the user |
| | empties the pockets as they become full |
| | then the sorter will cycle between using |
| | pocket 5c, pocket 5b and pocket 5a. When |
| | switching pockets, the sorter will always |
| | use pocket 5c if it is available. In this |
| | mode there is no separate configuration |
| | control for pocket 5b. |
| | The sorter will also stop whenever the |
| | cull pocket 6 becomes full. |
| | This mode is used typically for continuous |
| | count operations with no sort required. |

The banknote sorter 1 selects the stop mode automatically in order to keep the user interface as simple as possible. By default, the single stop mode is used. However, if the user configures output pockets 5b and 5c to have identical settings then the cyclic A stop mode is used. If the output pockets 5a and 5b have no sort settings (i.e. they can accept any document) then the cyclic B stop mode is selected.

Note Recognition Control

Normally the banknote sorter 1 is used to process banknotes and the detector system 300 attempts to identify these notes. In some cases however, it is required to sort or count documents other than banknotes, for example cheques or vouchers. In this case, the document identification process is disabled and any detectors that rely on denomination information do not function.

Value Display

The number of documents in each output pocket 5a to 5c may be displayed on the display 11 as either the piece count (i.e. the number of documents in the pocket 5a to 5c) or the value of documents either as a total or by individual denominations. The user may switch between which of these is displayed at any time.

The type of display will not effect that way that the sorter 1 operates. Both are available regardless of the sort mode excepting those modes in which note recognition control is turned off.

The individual pocket displays 8a to 8c are limited to three digits and only display the piece count for that pocket.

Hotkey Modes

The most commonly used sorting programs are predefined and assigned to hotkeys as already described so that mode selection can be achieved by a single key press.

The following table shows the sort settings for the hotkey modes.

| | | | Pocket | Pocket 2 | | | | |
|---|---|---|---|---|---|---|---|---|
| Hotkey | Recognition | Mode | 1 (Bottom) | (Middle) | Pocket 3 (Top) | Cull | Stop Mode | Notes |
| Count | OFF | Fitness | OFF | OFF | OFF | Notes which are | CYCLIC B | Counts documents |
| (piece | | Denomination | OFF | OFF | OFF | rejected by any | (Stops when | other than |
| count of | | Issue | OFF | OFF | OFF | of the user- | all pockets | banknotes. |
| vouchers) | | Orientation | OFF | OFF | OFF | selected | are full) | Cycles continually |
| | | Face | OFF | OFF | OFF | detectors | | between pockets |
| | | | | | | | | until all become |
| | | | | | | | | full |
| Value | ON | Fitness | OFF | OFF | OFF | Unrecognised | CYCLIC B | Counts recognised |
| (piece | | Denomination | OFF | OFF | OFF | notes, other | (Stops when | banknotes. |
| count of | | Issue | OFF | OFF | OFF | denominations | all pockets | Cycles continually |
| banknotes) | | Orientation | OFF | OFF | OFF | and notes which | full) | between pockets |
| | | Face | OFF | OFF | OFF | are rejected by | | until all become |
| | | | | | | any of the | | full. |
| | | | | | | user-selected | | |
| | | | | | | detectors | | |
| ATM | ON | Fitness | ATM | TELLER | OFF(unfit) | Unrecognised | SINGLE | Sorts notes into |
| | | Denomination | AUTO-1 | AUTO-1 | AUTO-1 | notes, other | (Stops when | three predefined |
| | | Issue | OFF | OFF | OFF | denominations | any pocket | fitness |
| | | Orientation | OFF | OFF | OFF | and notes which | full) | categories. All |
| | | Face | OFF | OFF | OFF | are rejected by | | notes have the |
| | | | | | | the user- | | same denomination. |
| | | | | | | selected | | |
| | | | | | | detectors | | |
| ATM × 2 | ON | Fitness | ATM | ATM | OFF(unfit and | Unrecognised | CYCLIC A | Sorts ATM fit |
| | | Denomination | AUTO-1 | AUTO-1 | teller) | notes, other | (Stops when | notes into pockets |
| | | Issue | OFF | OFF | AUTO-1 | denominations | both pocket | 5b and 5c. |
| | | Orientation | OFF | OFF | OFF | and notes which | 5c and pocket | Continues until |
| | | Face | OFF | OFF | OFF | are rejected by | 5b are full) | both pockets |
| | | | | | OFF | the user- | | become full. |
| | | | | | | selected | | |
| | | | | | | detectors | | |
| FIT | ON | Fitness | TELLER | TELLER | OFF (unit) | Unrecognised | CYCLIC A | Sorts teller fit |
| | | Denomination | AUTO-1 | AUTO-1 | AUTO-1 | notes, other | (Stops | notes into pockets 5b |
| | | Issue | OFF | OFF | OFF | denominations | when both | and 5c. Continues |
| | | Orientation | OFF | OFF | OFF | and notes which | pocket 5c | until both pockets |
| | | Face | OFF | OFF | OFF | are rejected by | and pocket | become full. |
| | | | | | | the user- | 5b are | |
| | | | | | | selected | full) | |
| | | | | | | detectors | | |
| Denomination | ON | Fitness | OFF | OFF | OFF | Unrecognised | SINGLE | Sort of notes by |
| | | Denomination | AUTO-1 | AUTO-2 | OFF | notes and notes | (Stops | denominations. The |
| | | Issue | OFF | OFF | OFF | which are | when any | first two |
| | | Orientation | OFF | OFF | OFF | rejected by any | pocket | denominations are |
| | | Face | OFF | OFF | OFF | of the user- | full) | stacked into pockets |
| | | | | | (All remaining | selected | | 5b and 5c. |
| | | | | | notes) | detectors | | |
| Issue | ON | Fitness | OFF | OFF | OFF | Unrecognised | SINGLE | Sorts of notes by |
| | | Denomination | AUTO-1 | AUTO-1 | OFF | notes and notes | (Stops | issue. The first two |
| | | Issue | AUTO-1 | AUTO-2 | OFF | which are | when any | issues are stacked |
| | | Orientation | OFF | OFF | OFF | rejected by any | pocket | into pockets 5b and |
| | | Face | OFF | OFF | OFF | of the user- | full) | 5c. |
| | | | | | (All remaining | selected | | |
| | | | | | notes) | detectors | | |
| Orientation | ON | Fitness | OFF | OFF | OFF | Unrecognised | SINGLE | Sort of notes by face |
| | | Denomination | AUTO-1 | AUTO-1 | OFF | notes and notes | (Stops | and orientation. |
| | | Issue | OFF | OFF | OFF | which are | when any | Notes with the same |
| | | Orientation | AUTO-1 | AUTO-2 | OFF | rejected by any | pocket | face and orientation |
| | | Face | AUTO-1 | AUTO-1 | OFF | of the user- | full) | as the first note go |
| | | | | | (All remaining | selected | | to pocket 5c, notes |
| | | | | | notes) | detectors | | with the same face |
| | | | | | | | | but different |
| | | | | | | | | orientation go to |
| | | | | | | | | pocket 5b. |
| Face | ON | Fitness | OFF | OFF | OFF | Unrecognised | SINGLE | Sort of notes by |
| | | Denomination | AUTO-1 | AUTO-1 | OFF | notes and notes | (Stops | face. |
| | | Issue | OFF | OFF | OFF | which are | when any | Notes with the same |
| | | Orientation | OFF | OFF | OFF | rejected by any | pocket | face orientation as |
| | | Face | AUTO-1 | AUTO-2 | OFF | of the user- | full) | the first note are |
| | | | | | (All remaining | selected | | stacked into pocket |
| | | | | | notes) | detectors | | 5c, the rest go to |
| | | | | | | | | pocket 5b. |

Sitting and Standing Modes

The banknote sorting machine 1 has a user-settable mode that indicates whether it will be used in a standing or a sitting setup, that is whether the operators usually stand or set when using the machine.

In the sitting mode, the lowest pocket 5c is designated as the primary or priority pocket, and pocket 5c will then be filled first for the operator=s convenience. Conversely, in the standing mode, the highest pocket 5a is designated as the primary or priority pocket.

Typically, the priority pocket receives the first note fed from a stack of banknotes that meets a predefined set of characteristics (for example it has a predefined denomination). All subsequent notes meeting these characteristics are also fed to this pocket. The first and all subsequent notes meeting another set of characteristics (for example, a different denomination) are then fed to one of the other (non-priority) pockets.

One-and-a-Half Pass Sorting

In this sorting mode, the sorter receives a bundle of notes with a mixture of face-up and face-down facings. The notes with a face-up configuration having one orientation are fed to output pocket 5a (for example), and notes with a face-up configuration having the other orientation are fed to output pocket 5b (for example). All notes with a face-down configuration are fed to output pocket 5c. These notes are then removed from pocket 5c and placed back in the feed hopper 100 after being inverted so that they are now in a face-up configuration and can be sorted on their orientation into pockets 5a and 5b.

In this sorting mode, the value or piece count of the notes fed to pocket 5c is not added into the combined total value or piece count (which only includes the values or piece counts of pockets 5a and 5b). This allows the removal and resorting of notes from pocket 5c without interrupting machine operation.

A further advantage arises from the fact that there are a maximum of two incomplete bundles of notes at the end of a sorting operation, whilst in a four pocket machine which sorted facing and orientation simultaneously into the four pockets, there would be a maximum of four incomplete bundles.

Documents of No Value

It can be useful under some circumstances to allow documents of no value to be diverted into one of the output pockets 5a to 5c. For example, separator documents (which can include cards or paper slips from which information relating to a batch being sorted may be read by machine or human operator) are often used to indicate which till a portion of a stack of banknotes was removed from. It can be advantageous to divert these into a pocket 5a to 5c along with the banknotes but not to count them in the piece or value count.

Language Selection

The machine also can be forced to enter a language selection mode by switching it off and then switching it on whilst holding down a predefined key on the keypad. This can be useful if a user has inadvertently selected a language that they cannot understand so that they can easily revert by a known process to a language that they do understand without having to negotiate menus and screen layouts in a foreign language.

1. A banknote sorting device having two output pockets, each of which can be designated as a primary or a secondary output pocket, wherein the banknote sorting device is switchable between a sitting mode in which the lower of the two output pockets is designated the primary output pocket and the upper of the two output pockets is designated the secondary output pocket, and a standing mode in which the designation of the primary and secondary output pockets is reversed.

2. A banknote sorting device according to claim 1, wherein the primary output pocket is a priority pocket.

3. A banknote sorting device according to claim 2, wherein the priority pocket receives the first note from a stack of banknotes fed into the banknote sorting device that meets a first predefined set of characteristics along with all subsequent notes meeting the first predefined set of characteristics.

4. A banknote sorting device according to claim 3, wherein the secondary pocket receives the second note from a stack of banknotes fed into the banknote sorting device that meets a second predefined set of characteristics along with all subsequent notes meeting the second predefined set of characteristics.

5. A banknote sorting device according to claim 3, wherein the first predefined set of characteristics may include one or more of: a note's denomination; a note=s fitness; a note's facing; a note's orientation; a note's currency; and a note's authenticity.

6. A banknote sorting device according to claim 3, wherein the second predefined set of characteristics may include one or more of: a note's denomination; a note's fitness; a note's facing; a note's orientation; a note's currency; and a note's authenticity.
